(19) United States
(12) Patent Application Publication
(10) Pub. No.: US 2023/0095648 A1
(43) Pub. Date: Mar. 30, 2023

(54) SERVER, HOME APPLIANCE, AND METHOD, PERFORMED BY THE SERVER, OF PROVIDING ARTIFICIAL INTELLIGENCE RECOMMENDATION SERVICE TO THE HOME APPLIANCE

(71) Applicant: SAMSUNG ELECTRONICS CO., LTD., Suwon-si (KR)

(72) Inventors: Jooyoo KIM, Suwon-si (KR); Hyungseon SONG, Suwon-si (KR); Kyungjae KIM, Suwon-si (KR); Jongyoub RYU, Suwon-si (KR); Dongjun SHIN, Suwon-si (KR); Yoonhee CHOI, Suwon-si (KR)

(73) Assignee: SAMSUNG ELECTRONICS CO., LTD., Suwon-si (KR)

(21) Appl. No.: 17/869,961

(22) Filed: Jul. 21, 2022

Related U.S. Application Data
(63) Continuation of application No. PCT/KR2022/009754, filed on Jul. 6, 2022.

(30) Foreign Application Priority Data
Sep. 28, 2021 (KR) 10-2021-0128343

(51) Int. Cl. G06N 20/00

(52) U.S. Cl. CPC G06N 20/00

(57) ABSTRACT

Provided are a server for providing a course recommendation service to a cycle-based new home appliance, and an operation method of the server. The server receives a signal requesting a course recommendation service from a home appliance, determines whether the home appliance is a new device, converts existing first cycle history data associated with an existing home appliance before use of the home appliance and that is a same type as the home appliance into second cycle history data corresponding to the home appliance, obtains information associated with a recommended course of the home appliance by using the second cycle history data, and transmits the obtained information about the recommended course of the home appliance to the home appliance.

### CROSS-REFERENCE TO RELATED APPLICATION

This application is a continuation application, under 35 U.S.C. § 111(a), of international application No. PCT/KR2022/009754, filed on Jul. 6, 2022, which is claims priority under 35 U.S.C. § 119 to Korean Patent Application No. 10-2021-0128343 filed on Sep. 28, 2021, the disclosures of which are incorporated herein by reference in their entirety.

### BACKGROUND FIELD

The disclosure relates to a server, a home appliance, and operation methods of the server and the home appliance. More particularly, the disclosure relates to a server, and a method, performed by the server, of providing an artificial intelligence recommendation service to a cycle-based home appliance that performs a plurality of operations according to a preset order.

### DESCRIPTION OF RELATED ART

Recently, as technologies such as artificial intelligence (AI) (for example, machine learning or deep learning) are developed, intelligent services that provide data-related information or data-related services by automatically recognizing data such as voice, images, video, or text are being used in various fields.

AI systems are computer systems that implement human-level intelligence. Unlike existing rule-based smart systems, AI systems train themselves and make determinations spontaneously to become smarter. Because AI systems increase a recognition rate and more accurately understand a user's preferences the more they are used, existing rule-based smart systems are being gradually replaced by deep-learning AI systems.

AI technology includes machine learning (e.g., deep learning) and element technologies employing machine learning. Machine learning is an algorithm technology that self-classifies/learns the characteristics of input data, and each of the element technologies is a technology of mimicking functions of human brains, such as perception and determination, by using a machine learning algorithm, such as deep learning, and includes technical fields such as linguistic understanding, visual understanding, deduction/prediction, knowledge representation, and operation control.

AI technology has also been applied to home appliances and has been used for purposes such as recommendation of operation modes. In particular, in recent years, AI technology has been applied to cycle-based home appliances that perform a plurality of operations in a predetermined order, for example, washing machines, dryers, and clothes care systems, to provide a recommendation service of a course or setting values according to the course. In order for cycle-based home appliances to provide a course or setting value recommendation service by using AI technology, a certain amount or more of cycle history data must be accumulated. Cycle-based home appliances, such as washing machines, dryers, and clothes care systems, require a long time to accumulate usage histories of a cycle. When a new cycle-based home appliance is purchased to replace an existing home appliance or the new home appliance is added to the existing home appliance, because cycle history data is not accumulated in the new home appliance, a server should accumulate and store cycle history data again from the beginning in order to provide an AI course recommendation service to the new home appliance. Therefore, it takes a long time for the server to provide the AI course recommendation service to the new home appliance, and user convenience is low. In addition, when the new home appliance does not have the same function, course, or setting values as that of the existing home appliance, the new home appliance cannot utilize the cycle history data of the existing home appliance without changes.

### SUMMARY

According to an embodiment of the disclosure, a method, performed by a server, of providing an artificial intelligence (AI) service includes receiving, from a home appliance, a signal requesting a course recommendation service, determining whether the home appliance is a new device, based on device registration information and usage history information of the home appliance, when the home appliance is determined as the new device, converting existing first cycle history data associated with an existing home appliance before use of the home appliance and that is a same type as the home appliance into second cycle history data corresponding to the home appliance, obtaining information associated with a recommended course of the home appliance by applying the second cycle history data as input data to a first AI model, and transmitting, to the home appliance, the information associated with the recommended course of the home appliance.

The determining of whether the home appliance is the new device may include identifying the home appliance as the new device, when a registration period of the home appliance is within a preset threshold period and a number of times of use of the home appliance is less than a preset threshold number.

According to an embodiment of the disclosure, the first cycle history data may include information associated with at least one of a course name of a course performed by the existing home appliance, a frequency of use for each course, a use time for each course, a use date for each course, a day of the week for each course, or setting values related to a plurality of operations included in each course.

According to an embodiment of the disclosure, the converting of the first cycle history data into the second cycle history data is based on a preset course mapping relationship between courses of the existing home appliance and courses of the new home appliance.

According to an embodiment of the disclosure, the AI model is a first AI model and the converting of the first cycle history data into the second cycle history data may include extracting at least one feature value from the first cycle history data, performing inference through a second AI model by applying the extracted at least one feature value as input data to the second AI model, and converting the first cycle history data into the second cycle history data, based on a label obtained through the inference.

According to an embodiment of the disclosure, the second AI model may be a model trained through supervised learning in which a course executable by the existing home appliance and a feature value extracted from cycle information of the course are applied as input data and a label representing a course executable by the home appliance is applied as output data.

According to an embodiment of the disclosure, the cycle information of the course may include information associated with at least one of a plurality of operations included in a cycle constituting the course, an order of performing the plurality of operations, or setting values of the plurality of operations.

According to an embodiment of the disclosure, the converting of the first cycle history data into the second cycle history data may include obtaining a mapping relationship between first cycle information according to the course executable by the existing home appliance and second cycle information according to the course executable by the home appliance, based on a similarity between the first cycle information and the second cycle information, and converting the first recommended course into the second recommended course, based on the obtained mapping relationship.

According to an embodiment of the disclosure, the obtaining of the information associated with the recommended course of the home appliance may include obtaining, from the home appliance, use environment information including information associated with at least one of a usage time, a usage date, a day of the week, an external temperature, humidity, or fine dust, extracting a feature value from the use environment information, generating a feature vector by using the extracted feature value and a feature value extracted from the second cycle history data, and obtaining a label representing the recommended course of the home appliance, by applying the feature vector as input data to the first AI model and performing inference through the first AI model.

According to an embodiment of the disclosure, the converting of the first cycle history data into the second cycle history data may include generating a first feature vector by using a feature value extracted from the first cycle history data, and converting the first feature vector into a second feature vector corresponding to the second cycle history data, and the obtaining of the information associated with the recommended course of the home appliance may include obtaining a label representing the recommended course of the home appliance, by applying the second feature vector and a third feature vector extracted from use environment information of the home appliance as input data to the first AI model and performing inference through the first AI model.

According to another embodiment of the disclosure, a server for providing an AI service to a home appliance is provided. The server may include a communication interface, a memory storing cycle history data of at least one home appliance and at least one instruction, and at least one processor configured to execute the at least one instruction stored in the memory. The at least one processor may be configured to execute the at least one instruction to receive a signal requesting a course recommendation service from the home appliance through the communication interface, determine whether the home appliance is a new device, based on device registration information and usage history information of the home appliance, when the home appliance is determined as the new device, convert existing first cycle history data associated with an existing home appliance before use of the home appliance and that is a same type as the home appliance into second cycle history data corresponding to the home appliance, obtain information associated with a recommended course of the home appliance by applying the second cycle history data as input data to a first AI model, and control the communication interface to transmit, to the home appliance, the information associated with the recommended course of the home appliance.

According to an embodiment of the disclosure, the first cycle history data may include information associated with at least one of a course name of a course performed by the existing home appliance, a frequency of use for each course, a use time for each course, a use date for each course, a day of the week for each course, or setting values related to a plurality of operations included in each course.

According to an embodiment of the disclosure, the at least one processor may be further configured to convert the first cycle history data into the second cycle history data, based on a preset course mapping relationship between courses of the existing home appliance and courses of the new home appliance.

According to an embodiment of the disclosure, the at least one processor may be further configured to extract at least one feature value from the first cycle history data, perform inference through a second AI model by apply the extracted at least one feature value as input data to the second AI model, and convert the first cycle history data into the second cycle history data, based on a label obtained through the inference.

According to an embodiment of the disclosure, the second AI model may be a model trained through supervised learning in which a course executable by the existing home appliance and a feature value extracted from cycle information of the course are applied as input data and a label representing a course executable by the home appliance is applied as output data.

According to an embodiment of the disclosure, the cycle information of the course may include information associated with at least one of a plurality of operations included in a cycle constituting the course, an order of performing the plurality of operations, or setting values of the plurality of operations.

According to an embodiment of the disclosure, the at least one processor may be further configured to obtain a mapping relationship between first cycle information according to the course executable by the existing home appliance and second cycle information according to the course executable by the home appliance, based on a similarity between the first cycle information and the second cycle information, and convert the first recommended course into the second recommended course, based on the obtained mapping relationship.

According to an embodiment of the disclosure, the at least one processor may be further configured to obtain use environment information including information associated with at least one of a usage time, a usage date, a day of the week, an external temperature, humidity, or fine dust from the home appliance through the communication interface, extract a feature vector from the use environment information, generate a feature vector by using the extracted feature value and a feature value extracted from the second cycle history data, and obtain a label representing the recommended course of the home appliance, by applying the feature vector as input data to the first AI model and performing inference through the first AI model.

According to an embodiment of the disclosure, the at least one processor may be further configured to generate a first feature vector by using a feature value extracted from the first cycle history data, convert the first feature vector into a second feature vector corresponding to the second cycle history data, and obtain a label representing the recommended course of the home appliance, by applying the second feature vector and a third feature vector extracted from use environment information of the home appliance as input data to the first AI model and performing inference through the first AI model.

According to another embodiment of the disclosure, provided is a non-transitory computer-readable recording medium having recorded thereon a computer program.

### BRIEF DESCRIPTION OF DRAWINGS

This disclosure may be readily understood by reference to the following detailed description and the accompanying drawings, in which reference numerals refer to structural elements.

FIG. 1 is a view illustrating some components of a server, an existing home appliance, and a new home appliance, according to an embodiment of the disclosure.

FIG. 2 is a block diagram of components of a server according to an embodiment of the disclosure.

FIG. 3 is a diagram for explaining a data flow between components included in a server according to an embodiment of the disclosure and a data flow between an existing home appliance and a new home appliance and the server.

FIG. 4 is a flowchart of an operation method of a server according to an embodiment of the disclosure.

FIG. 5 is a flowchart of a method, performed by a server, of recognizing a conversion situation of cycle history data of an existing home appliance, according to an embodiment of the disclosure.

FIG. 6 is a diagram for explaining an operation, performed by a server, of converting cycle history data, based on a mapping relationship between courses, according to an embodiment of the disclosure.

FIG. 7A is a diagram for explaining a training process of an artificial intelligence (AI) conversion model for cycle history data conversion, according to an embodiment of the disclosure.

FIG. 7B is a diagram for explaining an operation, performed by a server, of converting cycle history data by using an AI conversion model, according to an embodiment of the disclosure.

FIG. 8 is a diagram for explaining an operation, performed by a server, of converting cycle history data, based on a similarity between pieces of cycle information, according to an embodiment of the disclosure.

FIG. 9 is a flowchart of a method, performed by a server according to an embodiment of the disclosure, of obtaining information about a recommended course, based on cycle history data obtained to correspond to a new home appliance and use environment information.

FIG. 10 is a diagram for explaining an operation, performed by the server according to an embodiment of the disclosure, of obtaining information about a recommended course, based on cycle history data obtained to correspond to a new home appliance and a use environment information.

FIG. 11 is a diagram for explaining an operation, performed by the server according to an embodiment of the disclosure, of obtaining information about a recommended course, based on cycle history data obtained to correspond to a new home appliance and a use environment information.

FIG. 12 is a diagram for explaining an operation, performed by the server according to an embodiment of the disclosure, of obtaining information about a recommended course, based on cycle history data obtained to correspond to a new home appliance and a use environment information.

FIG. 13 is a flowchart of an operation method of a server according to an embodiment of the disclosure.

FIG. 14 is a block diagram of components of a home appliance according to an embodiment of the disclosure.

FIG. 15 is a flowchart of respective operations of a server, an existing home appliance, and a new home appliance, and data flow therebetween, according to an embodiment of the disclosure.

FIG. 16A is a view illustrating an operation, performed by a washing machine according to an embodiment of the disclosure, of displaying a user interface (UI) representing a recommended course and setting values of the recommended course.

FIG. 16B is a view illustrating an operation, performed by a clothes care system according to an embodiment of the disclosure, of displaying a UI representing a recommended course.

### DETAILED DESCRIPTION OF EXEMPLARY EMBODIMENTS

Throughout the disclosure, the expression “at least one of a, b or c” indicates only a, only b, only c, both a and b, both a and c, both b and c, all of a, b, and c, or variations thereof.

Although general terms widely used at present were selected for describing the disclosure in consideration of the functions thereof, these general terms may vary according to intentions of one of ordinary skill in the art, case precedents, the advent of new technologies, or the like. Terms arbitrarily selected by the applicant of the disclosure may also be used in a specific case. In this case, their meanings need to be given in the detailed description of an embodiment of the disclosure. Hence, the terms must be defined based on their meanings and the contents of the entire specification, not by simply stating the terms.

An expression used in the singular may encompass the expression of the plural, unless it has a clearly different meaning in the context. Unless otherwise defined, all terms (including technical and scientific terms) used herein have the same meaning as commonly understood by one of ordinary skill in the art to which this disclosure belongs.

The terms “comprises” and/or “comprising” or “includes” and/or “including” when used in this specification, specify the presence of stated elements, but do not preclude the presence or addition of one or more other elements. The terms “unit”, “-er (-or)”, and “module” when used in this specification refers to a unit in which at least one function or operation is performed, and may be implemented as hardware, software, or a combination of hardware and software.

The expression “configured to (or set to)” used therein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may refer to a situation in which the system is “capable of” together with another device or parts. For example, the phrase “a processor configured (or set) to perform A, B, and C” may mean a dedicated processor (such as an embedded processor) for performing a corresponding operation, or a generic-purpose processor (such as a central processing unit (CPU) or an application processor (AP)) that can perform a corresponding operation by executing one or more software programs stored in a memory.

When an element (e.g., a first element) is “coupled to” or “connected to” another element (e.g., a second element), the first element may be directly coupled to or connected to the second element, or, unless otherwise described, a third element may exist therebetween.

An ‘artificial intelligence (AI) service’ used herein refers to a function and/or operation, performed by a server or a home appliance, of providing an inference result regarding input data by using an AI technology (e.g., a machine learning model, an artificial neural network (ANN) model, a deep neural network model, reinforcement learning, decision tree learning, or a classification model). According to an embodiment of the disclosure, the ‘input data’ may include at least one of cycle history data, use environment information, or a combination thereof.

According to an an embodiment of the disclosure, the AI service may be provided by a server to a home appliance. However, embodiments of the disclosure are not limited thereto. According to another embodiment of the disclosure, the AI service may be provided by a home appliance in an on-device manner.

A ‘cycle’ used herein refers to a series of processes in which operations are performed in a predetermined order after the power of a home appliance is switched from an off state to an on state, and are terminated. For example, a wash cycle represents a series of processes in which, after a washing machine is turned on, washing, rinsing, and spinning operations are sequentially performed and terminated. As another example, a dry cycle represents a series of processes in which, after a dryer is turned on, drum heating, air flow control, and rotation operations are sequentially performed and terminated.

In the disclosure, a ‘cycle-based home appliance’ refers to a home appliance configured to perform a cycle. The cycle-based home appliance may include, for example, a washing machine, a clothes dryer, a clothes care system (e.g., an air dresser), or a shoes care system, but embodiments of the disclosure are not limited thereto.

In the disclosure, ‘cycle history data’ refers to information about the history of cycle execution. According to an embodiment of the disclosure, the cycle history data may include information about at least one of a course name used by a home appliance, the frequency of use for each course, a use time, the date of use, a day of the week, or setting values related to a plurality of operations included in each course.

In the disclosure, a ‘course’ indicates a unit of cycle previously determined for a plurality of operations constituting a cycle, an execution order of the plurality of operations, and setting values relating to the plurality of operations. According to an embodiment of the disclosure, courses may be classified according to use environment information (e.g., a time, a date, a day, an external temperature, humidity, or fine dust), the type of management object (e.g., clothes, blankets, shoes, or outdoor in the case of a laundry course), and a management method (e.g., standard, boiled, strong, rinse only, or spinning only in the case of a laundry course). The laundry course may include, but is not limited to, a standard course, a quick laundry course, a boiled laundry course, a super strong laundry course, an economical laundry course, a wool/lingerie laundry course, a blanket course, a shoes course, a cloudy day laundry course, a fine dust course, or an AI customized course.

Provided are a server that provides an artificial intelligence (AI) course recommendation service based on cycle history data to a new home appliance by using the cycle history data of an existing home appliance, when a new cycle-based home appliance is purchased to replace an existing home appliance or the new cycle-based home appliance is added to the existing home appliance, and an operation method of the server. A server according to an embodiment of the disclosure may convert the cycle history data collected and stored from the existing home appliance into cycle history data corresponding to the new home appliance, and may provide a course recommendation service to the new home appliance by using the converted cycle history data.

Embodiments of the disclosure are described in detail herein with reference to the accompanying drawings so that this disclosure may be easily performed by one of ordinary skill in the art to which the disclosure pertain. The disclosure may, however, be embodied in many different forms and should not be construed as being limited to the examples set forth herein.

Embodiments of the disclosure now will be described more fully hereinafter with reference to the accompanying drawings.

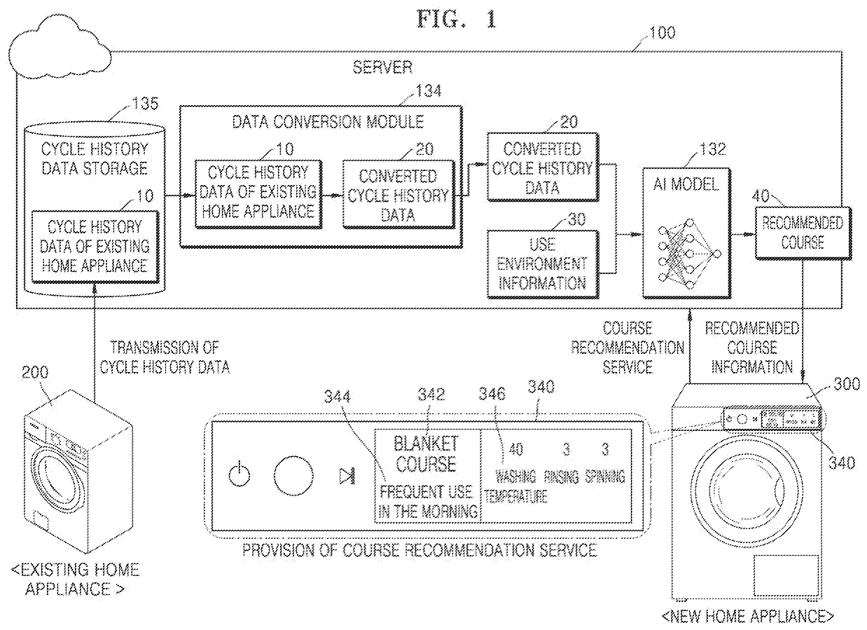

FIG. 1 is a view illustrating some components of a server 100, an existing home appliance 200, and a new home appliance 300 according to an embodiment of the disclosure.

Referring to FIG. 1, the server 100 may include an AI model 132, a data conversion module 134, and a cycle history data storage 135. In FIG. 1, the server 100 is illustrated to include only a configuration for describing the function and/or operations of the server 100, and the components included in the server 100 are not limited to those shown in FIG. 1.

The existing home appliance 200 may transmit cycle history data 10 to the server 100. The existing home appliance 200 may be a cycle-based home appliance that performs a plurality of operations in a predetermined order. According to an embodiment of the disclosure, the existing home appliance 200 may be a washing machine. However, embodiments of the disclosure are not limited thereto, and the existing home appliance 200 may be a dryer, a clothes care system (e.g., an air dresser), or a shoes care system. The existing home appliance 200 is a home appliance compared with the new home appliance 300, and may be a home appliance in which cycle history data is accumulated with a threshold value or greater. According to an embodiment of the disclosure, the existing home appliance 200 may be a home appliance in which a duration of registration in an Internet of Things (IoT) server or the server 100 is 21 days or more and a history of execution of a cycle (e.g., a wash cycle) by a user is 3 or more times. The IoT server is a server that obtains, stores, and manages device information about at least one home appliance. The existing home appliance 200 may transmit the cycle history data 10 about each executed cycle to the server 100. The cycle history data 10 may include information about at least one of a course name used by the existing home appliance 200, the frequency of use for each course, the time of use for each course, the date of use for each course, a day of the week for each course, or setting values related to a plurality of operations included in each course.

The server 100 may accumulate cycle history data of at least one home appliance registered in the server 100 or the IoT server and may store the accumulated cycle history data in the cycle history data storage 135. For example, the server 100 may accumulate the cycle history data 10 received from the existing home appliance 200, and may store the accumulated cycle history data 10 in the cycle history data storage 135.

The home appliance 300 is a device that is newly purchased to replace the existing home appliance 200 or to be added to the existing home appliance 200, and may be expressed as a new home appliance 300. The home appliance 300 may be a cycle-based home appliance, similar to the existing home appliance 200. According to an embodiment of the disclosure, the home appliance 300 may be a new device of which a device registration duration is less than 21 days and a history of execution of a cycle by a user is less than three times.

According to an embodiment of the disclosure, the home appliance 300 may be a home appliance that performs the same function and/or operation as the existing home appliance 200 and has the same device type as the existing home appliance 200. For example, when the existing home appliance 200 is a washing machine, the home appliance 300 may be a washing machine, and, when the existing home appliance 200 is a clothes dryer, the home appliance 300 may be a clothes dryer.

According to an embodiment of the disclosure, the home appliance 300 may be a device registered in the IoT server or the server 100 through the same user account (for example, a user ID) as the existing home appliance 200.

According to an embodiment of the disclosure, the home appliance 300 may replace the existing home appliance 200 and thus may be installed at the same location as a location of the existing home appliance 200 or at a location adjacent to the location where the existing home appliance 200 is installed.

The home appliance 300 may transmit a request signal requesting for a course recommendation service to the server 100. The ‘course recommendation service’ refers to a service in which the server 100 provides information about a course predicted to be used by a user through inference using the AI model 132, based on at least one of the cycle history data or use environment information 30. The home appliance 300 may be connected to the server 100 by using at least one data communication network from among, for example, a wired LAN, a wireless LAN, Wi-Fi, Bluetooth, Zigbee, Wi-Fi Direct (WFD), Bluetooth Low Energy (BLE), Wireless Broadband Internet (Wibro), World Interoperability for Microwave Access (WiMAX), a shared wireless access protocol (SWAP), Wireless Gigabit Allicance (WiGig), and RF communication, and may transmit a course recommendation service request signal to the server 100.

When the server 100 receives the course recommendation service request signal from the home appliance 300, the server 100 may identify whether the home appliance 300 is a new device, based on device registration information and usage history information of the home appliance 300. When the home appliance 300 is a new device, the server 100 may identify the existing home appliance 200 corresponding to the home appliance 300, based on the device type of the home appliance 300 and information about the location where the home appliance 300 is installed.

The server 100 may convert the cycle history data 10 of the existing home appliance 200 stored in the cycle history data storage 135 into cycle history data 20 corresponding to the home appliance 300 by using the data conversion module 134. The data conversion module 134 is a module configured to convert the course name of a course used by the existing home appliance 200 and setting values relating to a plurality of operations included in the course, which are included in the cycle history data 10, into a course name and setting values regarding a course executable by the existing home appliance 200, respectively.

According to an embodiment of the disclosure, the data conversion module 134 may convert the cycle history data 10 of the existing home appliance 200 into the cycle history data 20 corresponding to the home appliance 300, based on a preset mapping relationship between courses. According to another embodiment of the disclosure, the data conversion module 134 may convert the cycle history data 10 of the existing home appliance 200 into the cycle history data 20 corresponding to the home appliance 300 by using an AI conversion model. According to another embodiment of the disclosure, the data conversion module 134 may convert the cycle history data 10 of the existing home appliance 200 into the cycle history data 20 corresponding to the home appliance 300, based on a similarity between pieces of cycle information constituting courses.

The server 100 may obtain information about a recommended course predicted to be executed by a user, by applying the cycle history data 20 and the use environment information 30 as input data to the AI model 132 and performing inference through the AI model 132. The AI model 132 may be a machine learning model trained through supervised learning in which cycle history data and usage environment information are applied as input data and a label for the course used by the user is applied as an output value (e.g., ground-truth). The AI model 132 may be at least one model among, for example, a decision tree, a random forest, a Naïve Bayes classification network, a support vector machine (SVM), and an artificial neural network, but embodiments of the disclosure are not limited thereto.

The server 100 may receive the use environment information 30 from the home appliance 300 or obtain the use environment information 30 of the home appliance 300 from an external server. The use environment information 30 is information about an environment or situation in which the home appliance 300 is currently being used, and may include, for example, information about at least one of a usage time, a usage date, a day of the week, an external temperature, humidity, or fine dust.

The server 100 may transmit the obtained information about the recommended course 40 to the home appliance 300.

The home appliance 300 may provide a course recommendation service by using the information about the recommended course 40 received from the server 100. The home appliance 300 may include a display 340, and may display, on the display 340, user interfaces (UIs) 342, 344, and 346 indicating the information about the recommended course 40 received from the server 100. According to an embodiment of the disclosure, the home appliance 300 may display a first UI 342 indicating a recommended course, a second UI 344 indicating a course recommendation reason, and a third UI 346 indicating respective setting values for the operations of the recommended course.

The second UI 344 indicates the course recommendation reason in characters or numbers. The server 100 may identify a feature value that has affected a change in a weight or bias value within the AI model 132, and may transmit information about the identified feature value to the home appliance 300, during prediction of the recommended course 40 through the AI model 132. The home appliance 300 may obtain information about the course recommendation reason, based on the information about the identified feature value received from the server 100, and may display the second UI 344 indicating the information about the course recommendation reason. According to the embodiment of FIG. 1, when the feature value received from the server 100 is a feature value relating to a usage time, the second UI 344 may indicate the course recommendation reason through text “Frequent use in the morning”.

The third UI 346 represents setting values relating to a plurality of operations constituting a recommended course in the form of characters, numbers, or images. According to the embodiment of FIG. 1, when the recommended course is a blanket course, the third UI 346 may indicate respective setting values set for washing, rinsing, and spinning operations constituting the blanket course (for example, a washing temperature of 40°, rinsing 3 times, and a spinning intensity of 3).

In order for cycle-based home appliances, such as a washing machine, a clothes dryer, or a clothes care system, to provide a recommendation service of a course or setting values of the course by using AI technology, a certain amount or more of cycle history data needs to be accumulated. In general, cycle-based home appliances take a long time to accumulate usage histories of a cycle. When a new cycle-based home appliance is purchased to replace an existing home appliance or the new home appliance is added to the existing home appliance, because cycle history data is not accumulated in the new home appliance, the server 100 needs to accumulate and store cycle history data for a certain period of time or a certain number of times in order to provide an AI course recommendation service to the new home appliance. It takes long time for the new home appliance to accumulate cycle history data by performing a cycle for a certain period of time or a certain number of times, and a course recommendation service is not properly performed through the new home appliance while the cycle history data of the new home appliance is being accumulated. This may cause user inconvenience. In addition, when the new home appliance does not have the same function, course, or setting value as that of the existing home appliance, the new home appliance may not utilize the cycle history data of the existing home appliance without changes.

When the course recommendation service request signal is received from the new home appliance 300, the server 100 according to an embodiment of the disclosure may identify the existing home appliance 200 having the same type as the home appliance 300, convert the cycle history data 10 of the identified existing home appliance 200 into the cycle history data 20 corresponding to the home appliance 300, obtain the information about the recommended course 40 by using the cycle history data 20, and provide the obtained information about the recommended course 40 to the home appliance 300. When a user newly purchases the home appliance 300 to replace the existing home appliance 200 or adds the new home appliance 300 to the existing home appliance 200, the server 100 according to an embodiment of the disclosure may provide a course recommendation service based on a cycle use history of the existing home appliance 200 to the new home appliance 300, and therefore the new home appliance 300 may directly provide a service with continuity to the user despite such a device change. Moreover, according to an embodiment of the disclosure, even when the cycle history data about the new home appliance 300 is not accumulated and not stored, the information about the recommended course 40 based on the cycle use history of the existing home appliance 200 may be provided to the new home appliance 300, and thus user convenience may be improved.

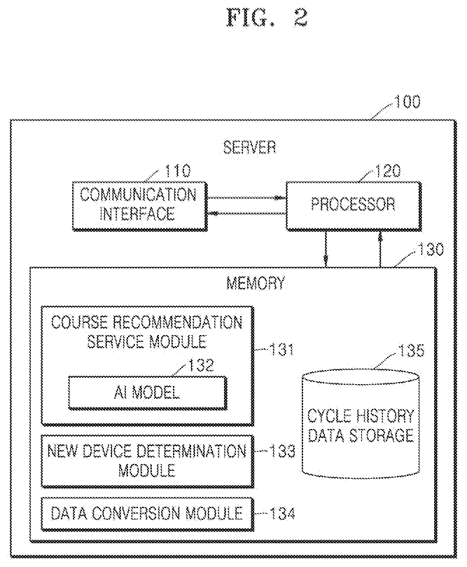

FIG. 2 is a block diagram of components of the server 100 according to an embodiment of the disclosure.

When the recommendation service request signal is received from the home appliance 300 of FIG. 1, the server 100 identifies whether the home appliance 300 is a new device, and, when the home appliance 300 is a new device, the server 100 converts first cycle history data of an existing home appliance into second cycle history data corresponding to the new home appliance 300, and provides an AI course recommendation service to the new home appliance 300 by using the second cycle history data.

Referring to FIG. 2, the server 100 may include a communication interface 110, a processor 120, and a memory 130.

The communication interface 110 is configured to perform data communication with at least one home appliance through a wired or wireless communication network. The communication interface 110 may perform data exchange with a home appliance by using at least one data communication network from among, for example, a wired LAN, a wireless LAN, Wi-Fi, Bluetooth, Zigbee, Wi-Fi Direct (WFD), Bluetooth Low Energy (BLE), Wireless Broadband Internet (Wibro), World Interoperability for Microwave Access (WiMAX), a shared wireless access protocol (SWAP), Wireless Gigabit Allicance (WiGig), and RF communication.

According to an embodiment of the disclosure, the communication interface 110 may receive the first cycle history data from the existing home appliance 200 of FIG. 1 or receive a request signal requesting for the course recommendation service from the new home appliance 300, under a control by the processor 120.

According to an embodiment of the disclosure, the communication interface 110 may transmit information about a recommended course to a new home appliance, under a control by the processor 120.

The processor 120 may execute one or more instructions of a program stored in the memory 130. The processor 120 may include hardware components that perform arithmetic, logic, input/output operations and signal processing. The processor 120 may include, but is not limited to, at least one of a central processing unit, a microprocessor, a graphics processing unit, application specific integrated circuits (ASICs), digital signal processors (DSPs), digital signal processing devices (DSPDs), programmable logic devices (PLDs), or field programmable gate arrays (fPGAs).

The processor 120 is illustrated as a single element in FIG. 2, but embodiments of the disclosure are not limited thereto. According to an embodiment of the disclosure, the processor 120 may be provided as one or in plurality.

According to an embodiment of the disclosure, the processor 120 may include an AI processor that perform AI learning. In this case, the AI processor may perform inference using the AI model 132. The AI processor may be manufactured in the form of an exclusive hardware chip for AI (for example, a neural processing unit (NPU)), or may be manufactured as a part of an existing general-purpose processor (for example, a central processing unit (CPU) or an application processor) or a graphic-dedicated processor (for example, a graphics processing unit (GPU)), and may be mounted on the server 100.

The memory 130 may include at least one type of storage medium from among, for example, a flash memory type storage medium, a hard disk type storage medium, a multimedia card micro type storage medium, a card type memory (for example, SD or XD memory), a random access memory (RAM), a static RAM (SRAM), a read-only memory (ROM), an electrically erasable programmable ROM (EEPROM), a programmable ROM (PROM), and an optical disk.

At least one of instructions, an algorithm, a data structure, program code, or an application program readable by the processor 120 may be stored in the memory 130. The instructions, algorithm, data structure, and program code stored in the memory 130 may be implemented in, for example, programming or scripting languages such as C, C++, Java, assembler, and the like.

The memory 130 may include a course recommendation service module 131, a new device determination module 133, a data conversion module 134, and a cycle history data storage 135. The course recommendation service module 131, the new device determination module 133, and the data conversion module 134 included in the memory 130 may refer to a unit for processing a function or operation performed by the processor 120, and may be implemented as software such as instructions or program code.

According to an embodiment below, the processor 120 may be implemented by executing the instructions or program codes of a program stored in the memory 130.

The course recommendation service module 131 is a software module configured to obtain and output recommended course information in response to a course recommendation service request signal obtained from a home appliance. According to an embodiment of the disclosure, the course recommendation service module 131 may include the AI model 132.

The AI model 132 may be a machine learning model trained through supervised learning in which at least one of cycle history data or usage environment information of at least one home appliance is applied as input data and a label for a course used by a user is applied as an output value (e.g., ground-truth). The AI model 132 may be at least one model among, for example, a decision tree, a random forest, a Naïve Bayes classification network, a support vector machine (SVM), and an artificial neural network, but embodiments of the disclosure are not limited thereto. According to an embodiment of the disclosure, the AI model 132 may be an ensemble model having a structure in which decision trees are combined.

According to an embodiment of the disclosure, the course recommendation service module 131 may apply the first cycle history data of the existing home appliance 200 as input data to the AI model 132 and may perform inference using the AI model 132. The processor 120 may obtain information about a course predicted to be used by a user through the existing home appliance 200 from the first cycle history data, by executing instructions or program code relating to the course recommendation service module 131.

According to an embodiment of the disclosure, the course recommendation service module 131 may apply, as input data, the second cycle history data obtained by the data conversion module 134 to correspond to the new home appliance 300 to the AI model 132, and may perform inference using the AI model 132. The processor 120 may obtain information about a course predicted to be used by the user through the new home appliance 300 from the second cycle history data, by executing the instructions or program code relating to the course recommendation service module 131.

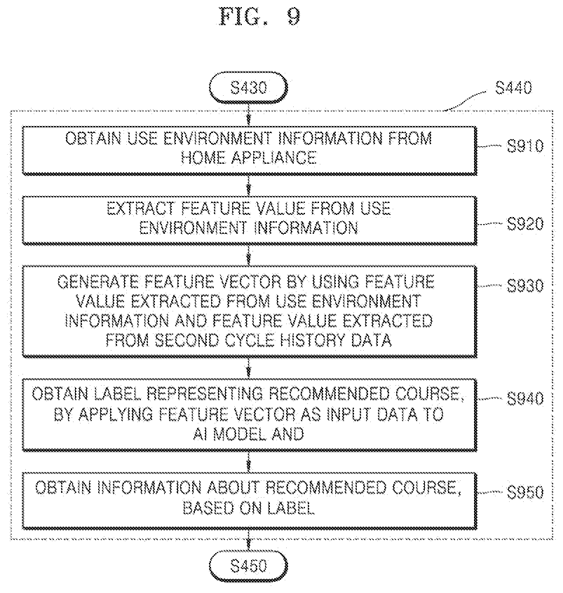

The course recommendation service module 131 may be configured to receive use environment information of the home appliance 300 when receiving the course recommendation service request signal from the home appliance 300. The use environment information is information about an environment or situation where the home appliance 300 is currently being used, and may include, for example, information about at least one of a usage time, a usage date, a day of the week, an external temperature, humidity, or fine dust. According to an embodiment of the disclosure, the processor 120 may control the communication interface 110 to receive the use environment information from the home appliance 300 or an external server (for example, a weather information providing server), by executing the instructions or program code relating to the course recommendation service module 131. The processor 120 may obtain the information about the course predicted to be used by the user through the home appliance 300, by performing inference in which not only the cycle history data but also the use environment information are applied as the input data to the AI model 132. A detailed embodiment in which the processor 120 obtains information about a recommended course by performing inference through the AI model 132 by applying at least one of the cycle history data or the use environment information as the input data will now be described in detail with reference to FIGS. 9 through 12.

The new device determination module 133 is a software module configured to determine the home appliance 300 having transmitted the request signal requesting for the course recommendation service is a new device. According to an embodiment of the disclosure, the new device determination module 133 may determine whether the home appliance 300 is a new device, based on the device registration information and the usage history information of the home appliance 300. The processor 120 may determine whether the home appliance 300 having transmitted the request signal requesting for the course recommendation service is a new device, by executing the instructions or program code relating to the new device determination module 133. According to an embodiment of the disclosure, the processor 120 may obtain the device registration information of the home appliance 300 from an IoT server through the communication interface 110, identify from the obtained device registration information whether a period during which the home appliance 300 has been registered in the IoT server is within a preset threshold period, and determine whether the home appliance 300 is a new device, based on a result of the identification. The ‘registration period’ refers to a period between a date when the course recommendation service request signal is received from the home appliance 300 and a date when the home appliance 300 is registered in the IoT server. According to an embodiment of the disclosure, when a cycle use number of the home appliance 300 is less than a preset threshold number, the processor 120 may determine that the home appliance 300 is a new device. For example, when the registration period of the home appliance 300 is within 21 days and the cycle use number is less than three times, the processor 120 may determine that the home appliance 300 is a new device. Hereinafter, the home appliance 300 determined as a new device may be defined as ‘a new home appliance 300’ to be distinguished from the existing home appliance 200.

When the home appliance 300 is determined as a new device, the processor 120 may identify the existing home appliance 200 corresponding to the new home appliance 300, based on registration information and user identification information (for example, a user ID) of the new home appliance 300. According to an embodiment of the disclosure, the processor 120 may identify the existing home appliance 200 having the same type as the new home appliance 300 and installed at the same location as or a location adjacent to the location of the new home appliance 300, from among one or more home appliances registered together with the new home appliance 300 in the user identification information at which the new home appliance 300 is registered in the IoT server. Information about the type and the installation location of the new home appliance 300 may be obtained from the registration information of the new home appliance 300. For example, when the new home appliance 300 is a newest model washing machine, the existing home appliance 200 may be an old model washing machine installed earlier at an installation location of the newest model washing machine.

The data conversion module 134 is a software module configured to convert the first cycle history data about the existing home appliance 200 into the second cycle history data corresponding to the new home appliance 300. The first cycle history data may be stored in the cycle history data storage 135. The first cycle history data may include information about at least one of the course names of courses performed by the existing home appliance 200, the frequency of use for each course, the time of use for each course, the date of use for each course, a day of the week for each course, or setting values related to a plurality of operations included in each course. When a cycle is performed by the existing home appliance 200, the server 100 may receive the first cycle history data from the existing home appliance 200 through the communication interface 110, and may store the received first cycle history data in the cycle history data storage 135. The server 100 may receive the first cycle history data from the existing home appliance 200 at every moment when a cycle is performed and completed, and may accumulate and store the received first cycle history data.

The data conversion module 134 may convert the course names of courses used by the existing home appliance 200 and setting values relating to a plurality of operations included in each of the courses, which are included in the first cycle history data of the existing home appliance 200, into course names and setting values relating to the courses executable by the new home appliance, respectively. According to an embodiment of the disclosure, the processor 120 may convert the first cycle history data of the existing home appliance 200 into the second cycle history data corresponding to the new home appliance 300, by executing the instructions or program code relating to the data conversion module 134.

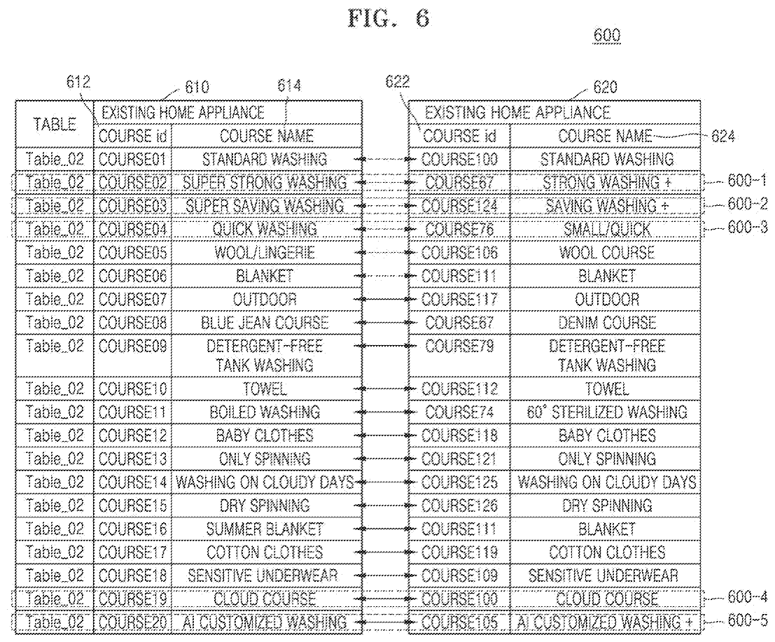

According to an embodiment of the disclosure, the processor 120 may convert the first cycle history data into the second cycle history data, based on a course mapping relationship between the courses of the existing home appliance 200 and the courses of the new home appliance 300. The course mapping relationship refers to a preset pairing relationship relating to identification information of at least one first course executable by the existing home appliance 200 and a course name of the at least one first course and identification information of at least one second course executable by the new home appliance 300 and a course name of the at least one second course. The course mapping relationship may be stored in the form of a mapping table in the data conversion module 134. The processor 120 may identify the course mapping relationship between the existing home appliance 200 and the new home appliance 300 by loading the mapping table from the data conversion module 134 and interpreting the loaded mapping table. However, embodiments of the disclosure are not limited thereto, and the mapping table may be stored in a storage space in the memory 130 accessible by the processor 120. A detailed embodiment in which the processor 120 converts the first cycle history data into the second cycle history data, based on the course mapping relationship, will be described in detail later with reference to FIG. 6.

According to an embodiment of the disclosure, the processor 120 may convert the first cycle history data into the second cycle history data corresponding to the new home appliance 300, through inference in which the first cycle history data is applied as input data to an AI conversion model. The AI conversion model may be a model trained through supervised learning in which a course executable by the existing home appliance 200 and a feature value extracted from cycle information of the course are applied as input data and a label representing a course executable by the new home appliance 300 is applied as an output value (for example, ground-truth). The ‘cycle information’ of the course included in the input data may include information about at least one of a plurality of operations included in a cycle constituting the course, an order of performing the plurality of operations, or setting values of the plurality of operations. For example, when the existing home appliance 200 is a ‘washing machine’, cycle information of a standard washing course may include a series of operations included in each of a washing cycle, a rinsing cycle, and a spinning cycle constituting the standard washing course, and setting values relating to the series of operations. The setting values may be, for example, option values set with respect to the washing temperature of the washing cycle, a rinsing number of the rinsing cycle, and a spinning intensity of the spinning cycle.

The AI conversion model may be at least one model among, for example, a decision tree, a random forest, a Naïve Bayes classification network, a support vector machine (SVM), and an artificial neural network, but embodiments of the disclosure are not limited thereto. According to an embodiment of the disclosure, the AI conversion model may be a deep neural network (DNN) model such as a convolutional neural network (CNN) model or a recurrent neural network (RNN) model.

According to an embodiment of the disclosure, the AI conversion model may be included in the data conversion module 134. However, embodiments of the disclosure are not limited thereto. According to another embodiment of the disclosure, the AI conversion model may be stored in the storage space in the memory 130 accessible by the processor 120.

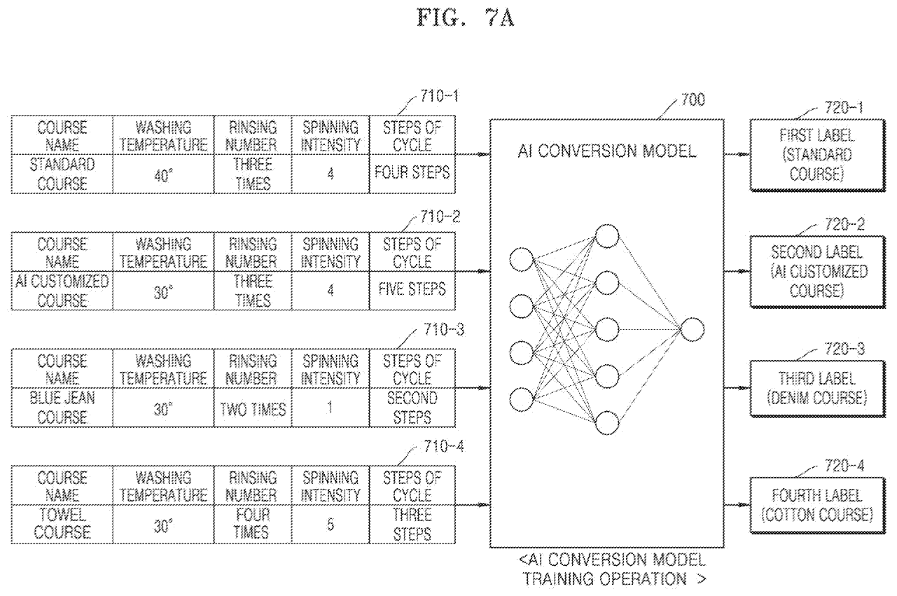

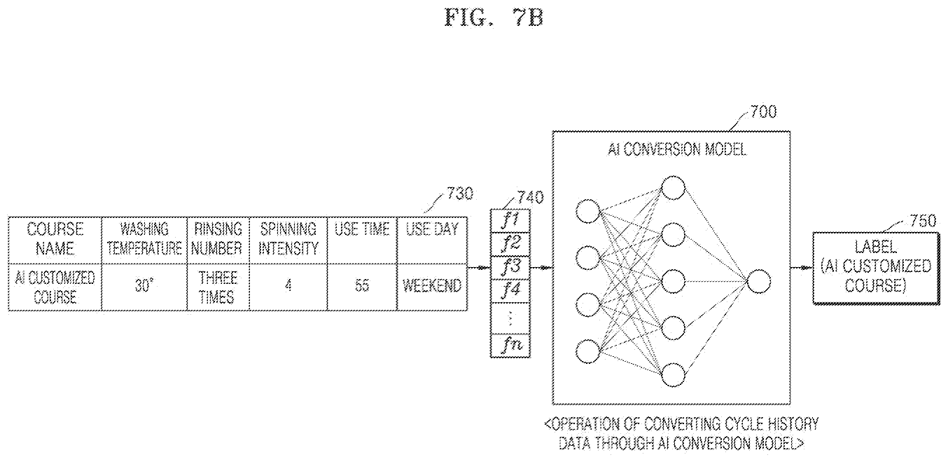

The processor 120 may extract at least one feature value from the first cycle history data of the existing home appliance 200, and may obtain a label through inference using the AI conversion model by applying the extracted at least one feature value as the input data to the AI conversion model. The processor 120 may obtain the second cycle history data corresponding to the new home appliance 300 from the first cycle history data, based on the obtained label. A detailed embodiment in which the processor 120 converts the first cycle history data into the second cycle history data by using the AI conversion model will be described in detail later with reference to FIGS. 7A and 7B.

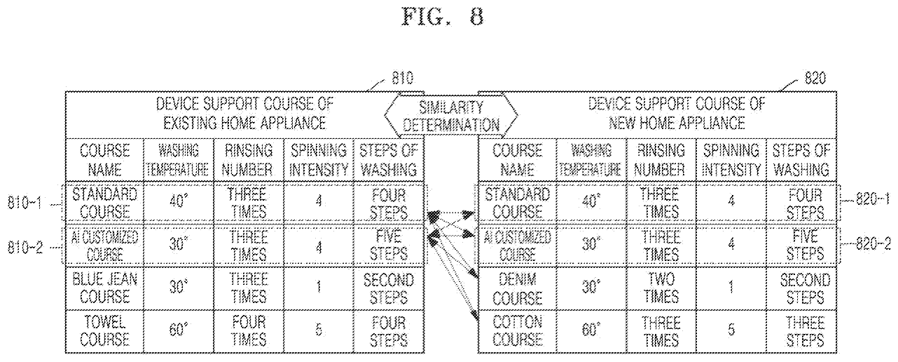

According to an embodiment of the disclosure, the processor 120 may convert the first cycle history data into the second cycle history data, based on a similarity between first cycle information according to a course executable by the existing home appliance 200 and second cycle information according to a course executable by the new home appliance 300. According to an embodiment of the disclosure, the processor 120 may calculate the similarity between the first cycle information and the second cycle information, and may obtain a mapping relationship between pieces of cycle information, based on the calculated similarity. The processor 120 may convert the first cycle history data into the second cycle history data, based on the obtained mapping relationship between the pieces of cycle information. A detailed embodiment in which the processor 120 converts the first cycle history data into the second cycle history data, based on the similarity between the first cycle information and the second cycle information will be described in detail later with reference to FIG. 8.

According to an embodiment of the disclosure, the data conversion module 134 may also convert the information about the recommended course output by the course recommendation service module 131. The processor 120 may convert a first recommended course output by the AI model 132 of the course recommendation service module 131 into a second recommended course corresponding to the new home appliance 300, by executing the instructions or program code relating to the data conversion module 134. For example, when the recommended course output by the AI model 132 is a ‘super-strong washing course’, the processor 120 may convert the ‘super-strong washing course’ into a ‘strong washing plus (+) course’ executable by the new home appliance 300 by using the data conversion module 134.

The cycle history data storage 135 is a database that stores the first cycle history data of the existing home appliance 200. According to an embodiment of the disclosure, the cycle history data storage 135 may store the second cycle history data obtained by the data conversion module 134.

The cycle history data storage 135 may be a non-volatile memory. The non-volatile memory refers to a storage medium that may store and maintain information even when power is not supplied and may use the stored information again when power is supplied. The non-volatile memory may include, for example, at least one of a flash memory, a hard disk, a solid state drive (SSD), a multimedia card micro type, and a card type memory (e.g., SD or XD memory), a ROM, a magnetic disk, or an optical disk. FIG. 2 illustrates that the cycle history data storage 135 is included in the memory 130, but embodiments of the disclosure are not limited thereto. According to an embodiment of the disclosure, the cycle history data storage 135 may be included in the server 100 but may be a separate component independent from the memory 130. However, embodiments of the disclosure are not limited thereto, and the cycle history data storage 135 is not included in the server 100 but may be implemented as a memory included in another server (for example, an IoT server) or another device (for example, a home appliance) or as a web-based storage medium.

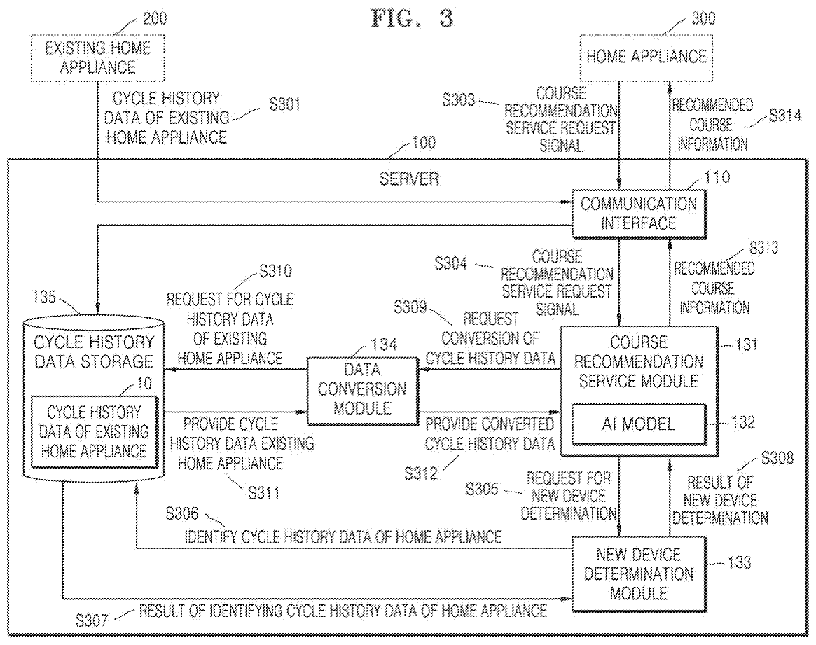

FIG. 3 is a diagram for explaining a data flow between components included in the server 100 according to an embodiment of the disclosure and a data flow between the existing home appliance 200 and the home appliance 300 and the server 100.

Referring to FIG. 3, the server 100 may include a communication interface 110, a course recommendation service module 131, a new device determination module 133, a data conversion module 134, and a cycle history data storage 135. The course recommendation service module 131 may include an AI model 132. The embodiment shown in FIG. 3 shows only the components necessary for explaining the data flow between the components included in the server 100. The components included in the server 100 are not limited to those shown in FIG. 3. The communication interface 110, the course recommendation service module 131, the new device determination module 133, the data conversion module 134, and the cycle history data storage 135 shown in FIG. 3 are the same as the communication interface 110, the course recommendation service module 131, the new device determination module 133, the data conversion module 134, and the cycle history data storage 135 shown in FIG. 2, and thus redundant descriptions regarding functions and/or operations of the components will be omitted.

Operations of the components shown in FIG. 3 may be performed by the processor 120 (see FIG. 2) of the server 100. Data transmission or reception between the components shown in FIG. 3 may be controlled by the processor 120.

In operation S301, the existing home appliance 200 transmits the cycle history data 10 to the server 100. When a cycle is performed according to a received user input, the existing home appliance 200 may transmit the cycle history data 10 to the communication interface 110 of the server 100. The cycle history data 10 transmitted by the existing home appliance 200 in operation S301 may include information about at least one of course names of courses used by the existing home appliance 200, the frequency of use for each course, the time of use for each course, the date of use for each course, a day of the week for each course, or setting values related to a plurality of operations included in each course.

In operation S302, the server 100 stores, in the cycle history data storage 135, the cycle history data 10 of the existing home appliance 200 received from the existing home appliance 200 through the communication interface 110. According to an embodiment of the disclosure, the server 100 may accumulate and store the cycle history data 10 of the existing home appliance 200 in the cycle history data storage 135 at every moment when the cycle history data 10 is received from the existing home appliance 200.

In operation S303, the home appliance 300 transmits a recommendation service request signal to the communication interface 110 of the server 100. The recommendation service request signal is a signal for requesting provision of recommendation information about a course predicted to be used by the user based on the cycle history data stored in the server 100. The home appliance 300 may transmit the recommendation service request signal to the server 100 in response to a user input of pressing a power button of the home appliance 300 or pressing a course recommendation related button, but embodiments of the disclosure are not limited thereto. According to an embodiment of the disclosure, the home appliance 300 may transmit the recommendation service request signal to the server 100 under a control through an application executed by a mobile device connected to the home appliance 300 through a short-distance communication network, such as Wi-Fi or Bluetooth.

In operation S304, the communication interface 110 provides the recommendation service request signal to the course recommendation service module 131.

In operation S305, in response to the recommendation service request signal, the course recommendation service module 131 transmits, to the new device determination module 133, a new device determination request signal for determining whether the home appliance 300 is a new device.

The new device determination module 133 may determine whether the home appliance 300 is a new device, based on the device registration information and the usage history information of the home appliance 300.

In operation S306, the new device determination module 133 identifies the cycle history data of the home appliance 300 from the cycle history data storage 135.

In operation S307, the new device determination module 133 receives a result of identifying the cycle history data of the home appliance 300 from the cycle history data storage 135. The new device determination module 133 may compare the data amount of the cycle history data of the home appliance 300 obtained from the cycle history data storage 135 with a preset threshold value, and may determine whether the home appliance 300 is a new device, according to a result of the comparison. According to an embodiment of the disclosure, when the registration period of the home appliance 300 is within 21 days and the cycle use number stored in the cycle history data storage 135 is less than three times, the new device determination module 133 may determine that the home appliance 300 is a new device.

In operation S308, the new device determination module 133 provides a new device determination result to the course recommendation service module 131.

In operation S309, when the home appliance 300 is determined as a new device according to the new device determination result obtained from the new device determination module 133, the course recommendation service module 131 transmits the cycle history data conversion request signal to the data conversion module 134. The cycle history data conversion request signal is a signal requesting conversion of the cycle history data 10 of the existing home appliance 200 stored in the cycle history data storage 135 into cycle history data corresponding to the home appliance 300.

In operation S310, the data conversion module 134 transmits a signal requesting for the cycle history data 10 of the existing home appliance 200 to the cycle history data storage 135. For example, the data conversion module 134 may identify the existing home appliance 200 corresponding to the home appliance 300, based on type information of the home appliance 300 and installation location information of the home appliance 300, and may request the cycle history data storage 135 for the cycle history data 10 of the existing home appliance 200.

In operation S311, the cycle history data storage 135 provides the cycle history data 10 of the existing home appliance 200 to the data conversion module 134, in response to the signal requesting for the cycle history data 10 of the existing home appliance 200. For example, the cycle history data storage 135 may search for the cycle history data 10 of the existing home appliance 200 from the cycle history data of the at least one home appliance, and may provide the cycle history data 10 of the existing home appliance 200 to the data conversion module 134. The data conversion module 134 may convert the cycle history data 10 of the existing home appliance 200 obtained from the cycle history data storage 135 into the cycle history data corresponding to the home appliance 300 determined as a new device. According to an embodiment of the disclosure, the data conversion module 134 may convert the cycle history data 10 of the existing home appliance 200 into the cycle history data corresponding to the home appliance 300, based on a preset mapping relationship between courses executed by the existing home appliance 200 and courses executed by the home appliance 300. According to another embodiment of the disclosure, the data conversion module 134 may convert the cycle history data 10 of the existing home appliance 200 into the cycle history data corresponding to the home appliance 300, by performing inference in which at least one feature value extracted from the cycle history data 10 of the existing home appliance 200 is applied as input data to the AI conversion model. According to another embodiment of the disclosure, the data conversion module 134 may convert the cycle history data 10 of the existing home appliance 200 into the cycle history data corresponding to the home appliance 300, based on the similarity between the first cycle information according to the course executable by the existing home appliance 200 and the second cycle information according to the course executable by the new home appliance 300.

In operation S312, the data conversion module 134 provides the cycle history data obtained as a result of the conversion to the course recommendation service module 131. The course recommendation service module 131 may obtain the information about the course predicted to be used by the user through the home appliance 300, by applying the cycle history data corresponding to a result of the conversion as the input data to the AI model 132 and performing inference using the AI model 132.

In operation S313, the course recommendation service module 131 provides the recommended course information to the communication interface 110.

In operation S314, the communication interface 110 transmits recommended course information to the home appliance 300. The home appliance 300 may display a UI representing the recommended course information received from the server 100. According to an embodiment of the disclosure, the home appliance 300 may display a UI representing not only the name of a recommended course but also a course recommendation reason.

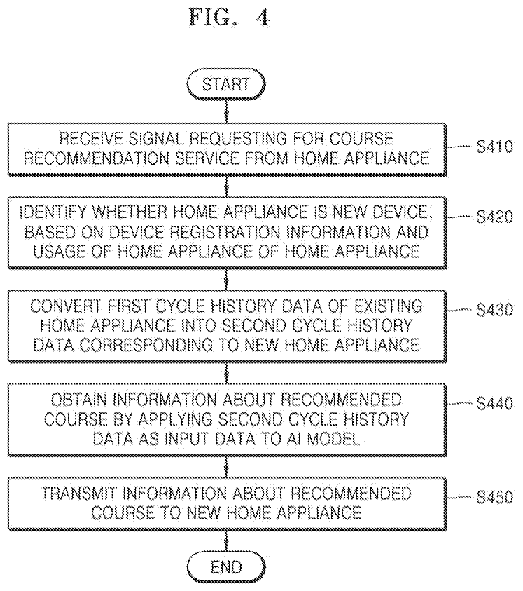

FIG. 4 is a flowchart of an operation method of the server 100 according to an embodiment of the disclosure.

In operation S410, the server 100 receives a signal requesting for a course recommendation service from a home appliance. The ‘course recommendation service’ refers to a service in which the server 100 provides information about a course predicted to be used by a user through inference using the AI model 132 of FIG. 2, based on at least one of cycle history data or use environment information. The server 100 may be connected to the home appliance by using at least one data communication network from among, for example, a wired LAN, a wireless LAN, Wi-Fi, Bluetooth, Zigbee, Wi-Fi Direct (WFD), Bluetooth Low Energy (BLE), Wireless Broadband Internet (Wibro), World Interoperability for Microwave Access (WiMAX), a shared wireless access protocol (SWAP), Wireless Gigabit Allicance (WiGig), and RF communication, and may receive the course recommendation service request signal from the home appliance.

According to an embodiment of the disclosure, the server 100 may receive the use environment information from the home appliance or an external server. The use environment information is information about an environment or situation where the home appliance is currently being used, and may include, for example, information about at least one of a usage time, a usage date, a day of the week, an external temperature, humidity, or fine dust.

In operation S420, the server 100 identifies whether the home appliance is a new device, based on device registration information and usage history information of the home appliance. According to an embodiment of the disclosure, when a device registration period of the home appliance is within a preset threshold period and a number of times of use of the home appliance is less than a preset threshold number, the server 100 may recognize the home appliance as a new device. The device registration period refers to a period between a date when the course recommendation service request signal is received from the home appliance and a date when the home appliance is registered in an IoT server. The server 100 may obtain the device registration information of the home appliance from the IoT server, and may identify the registration period of the home appliance from the device registration information.

For example, when the registration period of the home appliance is within 21 days and the cycle use number of the home appliance is less than three times, the server 100 may determine that the home appliance is a new device. In operations S430 through S450, the home appliance determined as a new device will be described as a ‘new home appliance’ to be distinguished from an existing home appliance.

In operation S430, when the home appliance determined as a new device, the server 100 converts first cycle history data of the existing home appliance into second cycle history data corresponding to the new home appliance. According to an embodiment of the disclosure, the server 100 may identify the existing home appliance corresponding to the new home appliance, based on registration information and user identification information (for example, a user ID) of the new home appliance. According to an embodiment of the disclosure, the server 100 may identify an existing home appliance having the same type as the new home appliance and installed at the same location as or a location adjacent to the location of the new home appliance from among one or more home appliances registered together with the new home appliance in the user identification information at which the new home appliance is registered in the IoT server.

The server 100 may convert the first cycle history data of the existing home appliance pre-stored in the cycle history data storage 135 of FIG. 2 into the second cycle history data corresponding to the new home appliance. The server 100 may convert the course name of a course used by the existing home appliance and setting values relating to a plurality of operations included in the course, which are included in the first cycle history data of the existing home appliance, into a course name and setting values relating to a course executable by the new home appliance, respectively.

According to an embodiment of the disclosure, the server 100 may convert the first cycle history data into the second cycle history data, based on a course mapping relationship between the courses of the existing home appliance and the courses of the new home appliance. The server 100 may load a mapping table defining a course mapping relationship from the memory 130 of FIG. 2, and may convert the first cycle history data into the second cycle history data, based on the mapping table.

According to an embodiment of the disclosure, the server 100 may convert the first cycle history data into the second cycle history data corresponding to the new home appliance, through inference in which the first cycle history data is applied as input data to an AI conversion model. The AI conversion model may be a model trained through supervised learning in which a course executable by the existing home appliance and a feature value extracted from cycle information of the course are applied as input data and a label representing a course executable by the new home appliance is applied as an output value (for example, ground-truth). The ‘cycle information’ of the course included in the input data may include information about at least one of a plurality of operations included in a cycle constituting the course, an order of performing the plurality of operations, or setting values of the plurality of operations.

The server 100 may extract at least one feature value from the first cycle history data of the existing home appliance, and may obtain a label through inference using the AI conversion model by applying the extracted at least one feature value as the input data to the AI conversion model. The server 100 may obtain the second cycle history data corresponding to the new home appliance from the first cycle history data, based on the obtained label.

According to an embodiment of the disclosure, the server 100 may obtain a mapping relationship between first cycle information according to the course executable by the existing home appliance and second cycle information according to the course executable by the new home appliance, based on a similarity between the first cycle information and the second cycle information, and may convert the first cycle history data into the second cycle history data, based on the mapping relationship.

In operation S440, the server 100 obtains information about a recommended course by applying the second cycle history data as input data to the AI model. According to an embodiment of the disclosure, the server 100 may output a label representing the information about the course predicted to be used by the user through the new home appliance, by applying the second cycle history data as the input data to the AI model 132 of FIG. 2 and performing inference through the AI model 132. The server 100 may obtain the information about the recommended course, based on the output label.

According to an embodiment of the disclosure, the server 100 may obtain the information about the recommended course by performing inference in which not only the second cycle history data but also the use environment information of the new home appliance received from the new home appliance or the external server are applied as input data to the AI model 132. The use environment information is information about an environment or situation where the home appliance is currently being used, and may include, for example, information about at least one of a usage time, a usage date, a day of the week, an external temperature, humidity, or fine dust.

In operation S450, the server 100 transmits the information about the recommended course to the new home appliance. According to an embodiment of the disclosure, the server 100 may transmit not only the information about the recommended course but also recommendation reason information about the recommended course to the new home appliance. According to an embodiment of the disclosure, in a process of performing inference by using the AI model 132, the server 100 may identify a feature value that affects a change in a weight and/or bias included in the AI model 132 among at least one feature value converted from the second cycle history data and the use environment information, and may identify information corresponding to the at least one feature value. For example, when the recommended course corresponding to the label output by the AI model 132 is ‘strong washing’, the server 100 may identify information about a day of the week when the recommended course is frequently used (for example, ‘weekend’) as feature value that has the greatest influence upon outputting the label corresponding to ‘strong washing’ during inference using the AI model 132, and may provide the new home appliance with information about a recommendation reason of ‘frequent use on weekends’ as the information about a day of the week when the recommended course is frequently used.

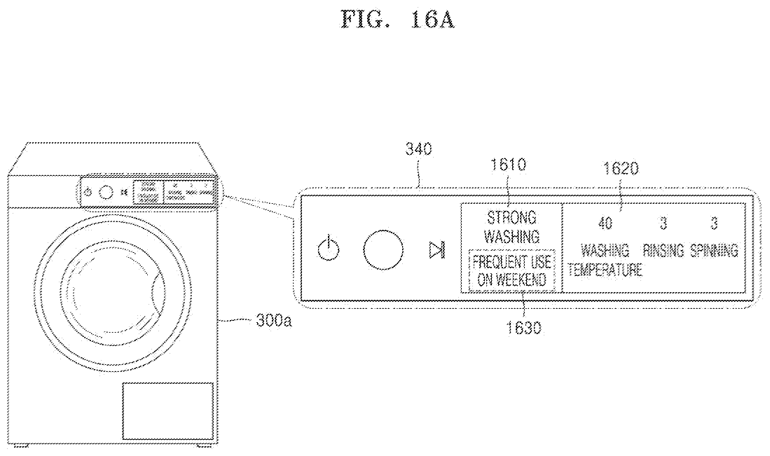

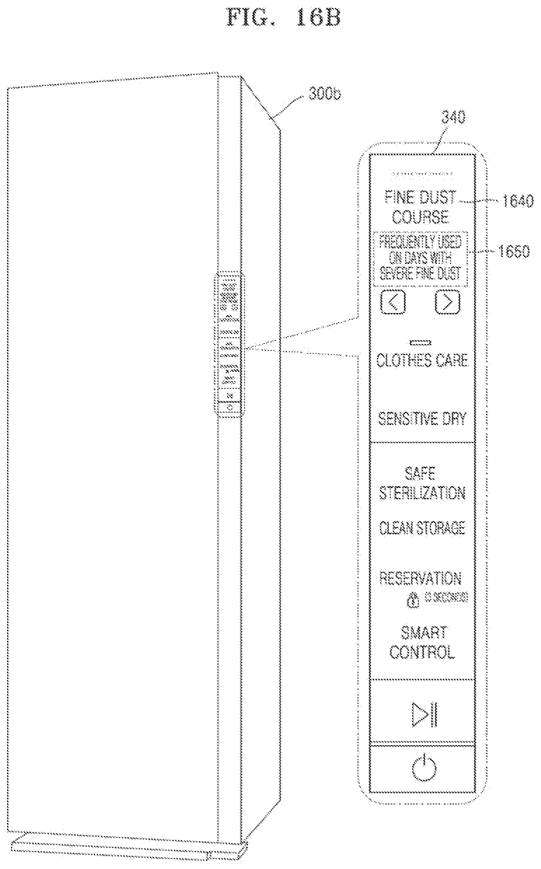

The new home appliance may display a UI representing not only the information about the recommended course but also the information about the recommendation reason, both received from the server 100. An embodiment in which the new home appliance displays a UI representing information about a recommended course and a recommendation reason will be described later with reference to FIGS. 16A and 16B.

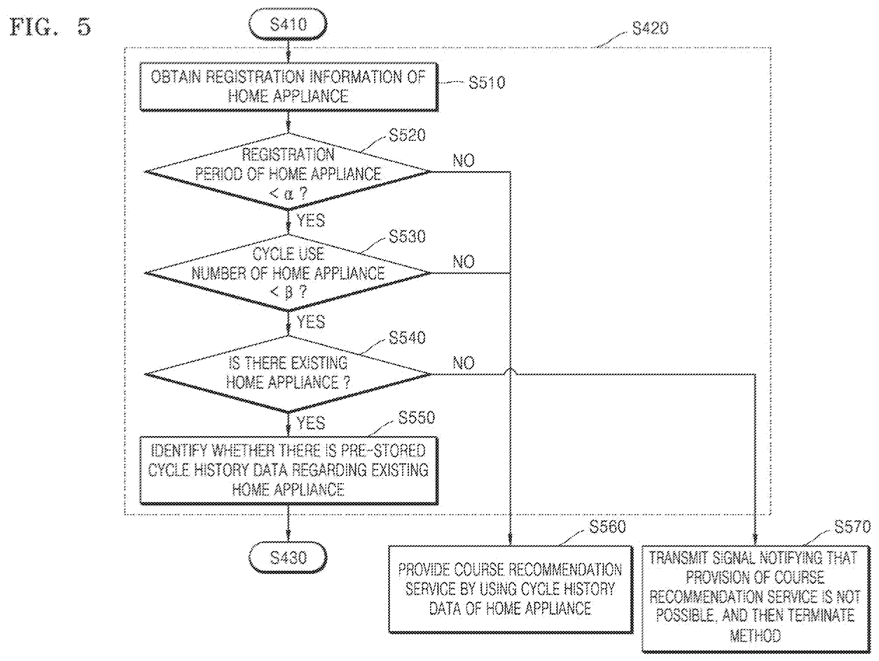

FIG. 5 is a flowchart of a method, performed by the server 100, of recognizing a conversion situation of cycle history data of an existing home appliance, according to an embodiment of the disclosure.

Operations S510 through S550 of FIG. 5 are detailed operations of operation S420 of FIG. 4. Operation S510 may be performed after operation S410 of FIG. 4 is performed. Operations S430 of FIG. 4 may be performed after operation S550 is performed.

In operation S510, the server 100 obtains registration information of a home appliance. According to an embodiment of the disclosure, the server 100 may obtain the registration information of the home appliance from an IoT server in which the home appliance has been registered. The IoT server is a server that obtains, stores, and manages device information about at least one home appliance. The IoT server may obtain, through a device registration process, device registration information including at least one of logged-in user account information (for example, user id) of at least one home appliance, a device registration date (for example, a registration day and a registration time), device identification information (for example, device id information), a device type (for example, a washing machine, a dryer, or a clothes care system), or a function execution capability from the at least one home appliance, and may store the obtained device registration information. The IoT server may be configured as a hardware device independent from the ‘server 100’ of the disclosure, but embodiments of the disclosure are not limited thereto. The IoT server may be one of some components of the server 100 of the disclosure, or may be an external server designed to be distinguished as software.

Embodiments of the disclosure are not limited to the server 100 obtaining the device registration information of the home appliance from the IoT server. According to an embodiment of the disclosure, the server 100 may directly obtain the registration information from the home appliance.

In operation S520, the server 100 compares a registration period of the home appliance with a preset threshold period α. The registration period refers to a period between a date when the course recommendation service request signal is received from the home appliance and a date when the home appliance is registered in the IoT server. According to an embodiment of the disclosure, the server 100 may obtain information about a registration date when the home appliance is registered in the IoT server, from the device registration information obtained in operation S510, and may calculate the registration period by using the obtained registration date and the information about the date of receiving the course recommendation service request signal obtained in operation S410. The ‘threshold period α’ is a predetermined period for determining whether the home appliance is a new device. The threshold period α may be, for example, 21 days, but embodiments of the disclosure are not limited thereto.

In operation S530, when the registration period of the home appliance is less than the threshold period α, the server 100 compares the cycle use number of the home appliance with a preset threshold number β. The ‘threshold number β’ represents a setting value regarding the number of times a cycle is performed, which is pre-set in order to determine that the home appliance is a new device. The threshold number β may be, for example, three times, but embodiments of the disclosure are not limited thereto.

When the cycle use number of the home appliance is less than the threshold number β (in operation S540), the server 100 determines whether there is the existing home appliance. The server 100 may identify the existing home appliance corresponding to the home appliance, based on the registration information and the user account information of the home appliance. According to an embodiment of the disclosure, the server 100 may identify an existing home appliance having the same type as the home appliance and installed at the same location as or a location adjacent to the location of the home appliance from among one or more home appliances registered together with the home appliance in the user identification information at which the home appliance is registered in the IoT server. For example, when the home appliance 300 is a newest model washing machine, the existing home appliance may be an old model washing machine installed earlier at an installation location of the newest model washing machine.

In operation S550, the server 100 identifies whether there is pre-stored cycle history data regarding the existing home appliance. According to an embodiment of the disclosure, the server 100 may determine that the home appliance is a new device, and may identify the first cycle history data about at least one cycles performed by the existing home appliance from among the cycle history data stored in the cycle history data storage 135 of FIG. 2. The first cycle history data may include information about at least one of the course name of a course performed by the existing home appliance, the frequency of use for each course, the time of use for each course, the date of use for each course, a day of the week for each course, or setting values related to a plurality of operations included in each course.

When the registration period of the home appliance is equal to or greater than the threshold period α or the cycle use number is equal to or greater than the threshold number β (in operation S560), the server 100 provides the course recommendation service by using the cycle history data of the home appliance. In operation S560, the server 100 may determine that sufficient cycle history data has already been stored to provide an AI course recommendation service to even the home appliance, and may provide the course recommendation service by using the cycle history data of the home appliance.

In operation S570, when the existing home appliance is not identified, the server 100 transmits a signal notifying that provision of the course recommendation service is not possible, and then terminates the method. When the home appliance is determined as the new device but the existing home appliance corresponding to a new device is not identified, the server 100 may transmit to the home appliance the signal notifying that provision of the course recommendation service is not possible. The home appliance may display a message notifying that course recommendation is not possible, based on the signal notifying that provision of the course recommendation service is not possible, received from the server 100.

FIG. 6 is a diagram for explaining an operation, performed by the server 100, of converting cycle history data, based on a mapping relationship between courses, according to an embodiment of the disclosure.

FIG. 6 illustrates a course mapping table 600 between courses of an existing home appliance and courses of a new home appliance. The course mapping table 600 may be stored in the data conversion module 134 (see FIG. 2) of the memory 130 of FIG. 2. However, embodiments of the disclosure are not limited thereto, and the course mapping table 600 may be stored in a space accessible by the processor 120 (see FIG. 2) within the storage space in the memory 130.

Referring to the course mapping table 600 of FIG. 6, the course mapping table 600 may include information about a mapping relationship between a first course table 610 representing course information about courses executable by the existing home appliance and a second course table 620 representing course information about courses executable by the new home appliance. The first course table 610 may include information about course identification information 612 and a course name 614 for each of one or more courses executable by the existing home appliance. The second course table 620 may include information about course identification information 622 and a course name 624 for each of one or more courses executable by the new home appliance.

The course mapping relationship refers to a preset pairing relationship relating to identification information of the one or more courses executable by the existing home appliance and course names of the one or more courses and identification information of the one or more courses executable by the new home appliance and course names of the one or more courses. The processor 120 (see FIG. 2) of the server 100 may convert a course executed by the existing home appliance into a course corresponding to the new home appliance, based on the course mapping relationship defined through the course mapping table 600. Referring to a first mapping relationship 600-1 of the course mapping table 600 of FIG. 6, a second course (course identification information: course 02, course name: super-strong washing) from among courses executable by the existing home appliance may be mapped with a sixty seventh course (course identification information: course 67, course name: strong washing +) from among courses executable by the new home appliance, and the processor 120 may convert cycle history data of the second course performed by the existing home appliance into cycle history data of the sixty seventh course corresponding to the new home appliance, based on the first mapping relationship 600-1. As another example, referring to a second mapping relationship 600-2 of the course mapping table 600 of FIG. 6, a third course (course identification information: course 03, course name: ultra-saving washing) from among the courses executable by the existing home appliance may be mapped with a 124^{th} course (course identification information: course 124, course name: saving washing +) from among the courses executable by the new home appliance, and the processor 120 may convert cycle history data of the third course performed by the existing home appliance into cycle history data of the 124^{th} course corresponding to the new home appliance, based on the second mapping relationship 600-2. As another example, referring to a third mapping relationship 600-3 of the course mapping table 600 of FIG. 6, a fourth course (course identification information: course 04, course name: quick washing) from among the courses executable by the existing home appliance may be mapped with a seventy sixth course (course identification information: course 76, course name: small/quick) from among the courses executable by the new home appliance, and the processor 120 may convert cycle history data of the fourth course performed by the existing home appliance into cycle history data of the seventy sixth course corresponding to the new home appliance, based on the third mapping relationship 600-3. Likewise, the processor 120 may convert cycle history data regarding a nineteenth course (course identification information: course 19, course name: cloud course) executed by the existing home appliance into cycle history data regarding a 100^{th} course (course identification information: course 100, course name: cloud course) corresponding to the new home appliance, based on a fourth mapping relationship 600-4, and may convert cycle history data regarding a twentieth course (course identification information: course 20, course name: AI customized washing) executed by the existing home appliance into cycle history data regarding a 105^{th} course (course identification information: course 105, course name: AI customized course) corresponding to the new home appliance, based on a fifth mapping relationship 600-5.

According to the embodiment of FIG. 6, by converting cycle history data regarding courses executed by the existing home appliance into cycle history data regarding courses corresponding to the new home appliance, based on the course mapping table 600 representing the preset course mapping relationship, the server 100 may improve conversion accuracy of the cycle history data, and may shorten a processing time taken for conversion, compared with when using a course similarity or using an AI conversion model 700 of FIGS. 7A and 7B.

FIG. 7A is a diagram for explaining a training process of the AI conversion model 700 for cycle history data conversion, according to an embodiment of the disclosure.

The server 100 may train the AI conversion model 700. According to an embodiment of the disclosure, the AI conversion model 700 may be included in the data conversion module 134 (see FIG. 2) of the memory 130 (see FIG. 2). However, embodiments of the disclosure are not limited thereto. According to another embodiment of the disclosure, the AI conversion model 700 may be stored in the storage space in the memory 130 accessible by the processor 120 of FIG. 2.

Referring to FIG. 7A, the AI conversion model 700 may be trained through supervised learning in which pieces of cycle information 710-1 through 710-4 of courses executable by an existing home appliance are applied as input data and labels 720-1 through 720-4 representing courses executable by a new home appliance are applied as output values (for example, ground-truth). The AI conversion model 700 may be at least one model among, for example, a decision tree, a random forest, a Naïve Bayes classification network, a support vector machine (SVM), and an artificial neural network, but embodiments of the disclosure are not limited thereto.

According to an embodiment of the disclosure, the AI conversion model 700 may be a DNN model such as a CNN model or a RNN model.

According to an embodiment of the disclosure, the processor 120 of the server 100 may extract feature values from the pieces of cycle information 710-1 through 710-4 of the courses executable by the existing home appliance and generate a feature vector by using the extracted feature values, and then may perform training in which the generated feature vector is applied as input data to the AI conversion model 700. For example, when the AI conversion model 700 is implemented as a CNN model, a parameter value including weights and biases of a plurality of layers included in the AI conversion model 700 may be changed through a training process.

According to an embodiment of the disclosure, when first cycle information 710-1 is applied as input data to the AI conversion model 700, the processor 120 may train the AI conversion model 700 by using a first label 720-1 as an output value. Likewise, the processor 120 may train the AI conversion model 700 by applying a second label 720-2 as an output value when second cycle information 710-2 is applied as input data, applying a third label value 720-3 as an output value when third cycle information 710-3 is applied as input data, and applying a fourth label value 720-4 as an output value when fourth cycle information 710-4 is applied as input data.

The pieces of first through fourth cycle information 710-1 through 710-4 of the courses included in the input data may include information about at least one of a plurality of operations included in cycles constituting the courses, an order of performing the plurality of operations, or setting values of the plurality of operations. According to the embodiment of FIG. 7A, the first cycle information 710-1 may include information about operations including washing, rinsing, and spinning of a first course, for example, a standard course, an operation execution order of washing, rinsing, and spinning, and setting values of the operations, such as a washing temperature, the number of times of rinsing, and a spinning intensity. The setting values of the operations in the first cycle information 710-1 may be, for example, a washing temperature of 40°, rinsing 3 times, and a spinning intensity of 4. The first cycle information 710-1 may further include information about steps of the cycle (for example, 4 steps). The second cycle information 710-2 may include information about operations including washing, rinsing, and spinning of an AI customized course, an operation execution order of washing, rinsing, and spinning, and setting values of the operations, such as a washing temperature, a rinsing number, and a spinning intensity. The setting values of the operations included in the AI customized course in the second cycle information 710-2 may be, for example, a washing temperature of 30°, a rinsing 3 times, and a spinning intensity of 4.

The first through fourth labels 720-1 through 720-4 applied as the output values when the AI conversion model 700 is trained may be feature values or a vector representing the courses executable by the new home appliance. According to the embodiment of FIG. 7A, the first label 720-1 may represent a standard course executable by the new home appliance. Likewise, the second label 720-2 may represent an AI customized course executable by the new home appliance, the third label 720-3 may represent a denim course executable by the new home appliance, and the fourth label 720-4 may represent a cotton course executable by the new home appliance.

FIG. 7B is a diagram for explaining an operation, performed by the server 100, of converting cycle history data by using an AI conversion model 700, according to an embodiment of the disclosure.

Referring to FIG. 7B, the server 100 may obtain a label 750 representing a course executable by a new home appliance, through inference that applies cycle history data 730 of an existing home appliance as input data to the AI conversion model 700. The AI conversion model 700 of FIG. 7B may be a model trained through the embodiment of FIG. 7A.

According to an embodiment of the disclosure, the processor 120 of the server 100 may extract one or more feature values from the cycle history data 730 and may obtain a feature vector 740 including the one or more feature values. The processor 120 may extract a plurality of feature values from information about a course name of a course, setting values of a plurality of operations included in the course, a use time, and a use day, which is included in the cycle history data 730, by using, for example, an encoding algorithm or a tokenization algorithm, and may generate the feature vector 740 by using the extracted plurality of feature values. The processor 120 may obtain the label 750 representing a course executable by the new home appliance, by applying the feature vector 740 as input data to the AI conversion model 700 and performing inference using the AI conversion model 700.

According to the embodiment of FIG. 7B, the cycle history data 730 of the existing home appliance relates to an AI customized course, and may include a cycle history in which washing, rinsing, and spinning operations were sequentially performed through the AI customized course, a washing temperature was 30°, the number of rinses was 3, and a spinning intensity was 4. The cycle history data 730 may also include information about a cycle use time (for example, 55 minutes) and a cycle use day (for example, weekends). When inference in which the feature vector 740 obtained from the cycle history data 730 is applied as input data to the AI conversion model 700 is performed, the label 750 representing the AI customized course executable by the new home appliance may be output. The processor 120 may convert the cycle history data 730 relating to the AI customized course of the existing home appliance into cycle history data relating to the AI customized course executable by the new home appliance, based on the second label 750.

Because the server 100 according to the embodiments of FIGS. 7A and 7B convert first cycle history data performed by the existing home appliance into second cycle history data of the new home appliance through inference using the AI conversion model 700, the server 100 may increase the accuracy of conversion even when there are no mapping tables.

FIG. 8 is a diagram for explaining an operation, performed by the server 100, of converting cycle history data, based on a similarity between pieces of cycle information, according to an embodiment of the disclosure.

Referring to FIG. 8, the server 100 may convert cycle history data of an existing home appliance into cycle history data corresponding to a new home appliance, based on a similarity between first cycle information 810 according to courses executable by the existing home appliance and second cycle information 820 according to courses executable by the new home appliance. The first cycle information 810 may include information about course names of the courses executable by the existing home appliance, execution orders of a plurality of operations included in the courses, and setting values of the plurality of operations. According to the embodiment of FIG. 8, first-first cycle information 810-1 of the first cycle information 810 relates to a standard course performed by the existing home appliance, and may include information about an execution order of washing, rinsing, and spinning constituting the standard course, and setting values including a washing temperature, a rinsing number, and a spinning intensity. Likewise, second first cycle information 810-2 of the first cycle information 810 relates to an AI customized course, and may include information about an execution order of washing, rinsing, and spinning constituting the AI customized course, and setting values including a washing temperature, a rinsing number, and a spinning intensity. The second cycle information 820 may include information about course names of the courses executable by the new home appliance, execution orders of a plurality of operations included in the courses, and setting values of the plurality of operations. According to the embodiment of FIG. 8, first second cycle information 820-1 of the second cycle information 820 relates to a standard course performed by the new home appliance, and may include information about an execution order of washing, rinsing, and spinning constituting the standard course, and setting values including a washing temperature, a rinsing number, and a spinning intensity. Likewise, second-second cycle information 820-2 of the second cycle information 820 relates to an AI course, and may include information about an execution order of washing, rinsing, and spinning constituting the AI course, and setting values including a washing temperature, a rinsing number, and a spinning intensity.

The processor 120 (see FIG. 2) of the server 100 may calculate a similarity between the first cycle information 810 and the second cycle information 820, and may obtain a mapping relationship between pieces of cycle information, based on the calculated similarity. According to an embodiment of the disclosure, the processor 120 may calculate the similarity by comparing the execution order of operations and the setting values of the operations in the first cycle information 810 with those in the second cycle information 820. For example, the processor 120 may calculate a similarity between the first second cycle information 820-1 and the second-second cycle information 820-2, based on the information about the execution order of washing, rinsing, and spinning, the washing temperature (for example, 40°), the rinsing number (for example, three times), the spinning intensity (for example, 4), and steps of washing (for example, 4 steps), which is included in the first-first cycle information 810-1. As another example, the processor 120 may calculate the similarity between the first second cycle information 820-1 and the second-second cycle information 820-2, based on the information about the execution order of washing, rinsing, and spinning, the washing temperature (for example, 30°), the rinsing number (for example, three times), the spinning intensity (for example, 4), and steps of washing (for example, 5 steps), which is included in the second-first cycle information 810-2.

The processor 120 may obtain a mapping relationship between the first cycle information 810 and the second cycle information 820, based on the similarity between the pieces of cycle information. According to an embodiment of the disclosure, the similarity calculated by the processor 120 may map the first cycle information 810 with the second cycle information 820. According to the embodiment of FIG. 8, the first-first cycle information 810-1 may have a maximum similarity with the first second cycle information 820-1 from among a plurality of pieces of cycle information included in the second cycle information 820, and the processor 120 may map the first-first cycle information 810-1 with the first second cycle information 820-1. Likewise, the second-first cycle information 810-2 may have a maximum similarity with the second-second cycle information 820-2 from among the plurality of pieces of cycle information included in the second cycle information 820, and the processor 120 may map the second-first cycle information 810-2 with the second-second cycle information 820-2.

The processor 120 may convert the cycle history data of the existing home appliance into the cycle history data corresponding to the new home appliance, based on the mapping relationship between the first cycle information 810 and the second cycle information 820. For example, when the cycle history data of the existing home appliance relates to the AI customized course, the processor 120 may convert first cycle history data relating to the AI customized course of the existing home appliance into second cycle history data relating to the AI course performed by the new home appliance, based on the mapping relationship between the pieces of cycle information.

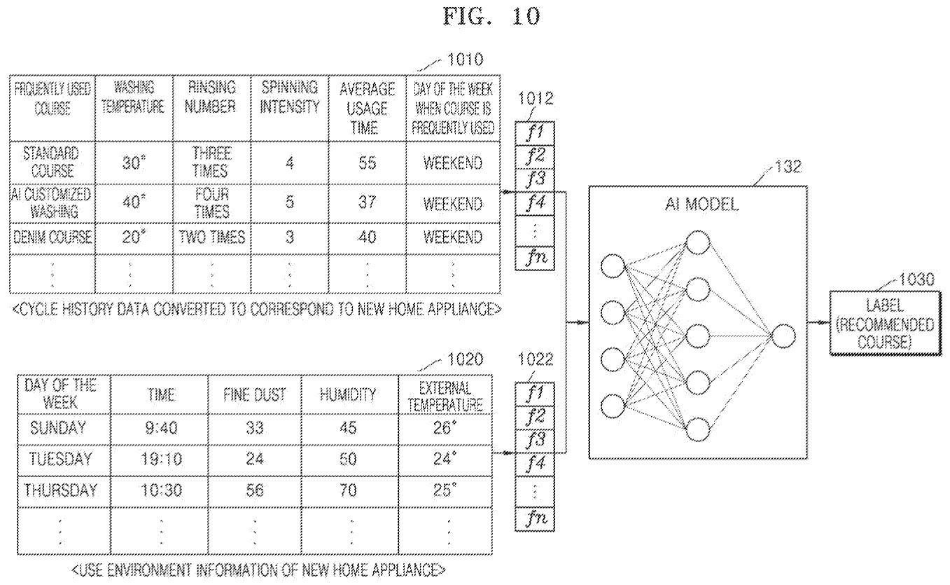

FIG. 9 is a flowchart of a method, performed by the server 100 according to an embodiment of the disclosure, of obtaining information about a recommended course, based on the cycle history data obtained to correspond to the new home appliance and the use environment information, and FIG. 10 is a diagram for explaining the operation, performed by the server 100 according to an embodiment of the disclosure, of obtaining information about a recommended course, based on the cycle history data obtained to correspond to the new home appliance and the use environment information.

An embodiment of obtaining information about a recommended course, based on the cycle history data obtained to correspond to the new home appliance and the use environment information will now be described with reference to FIGS. 9 and 10.

Operations S910 through S950 of FIG. 9 are detailed operations of operation S440 of FIG. 4. Operation S910 of FIG. 9 may be performed after operation S430 of FIG. 4 is performed. Operations S450 of FIG. 4 may be performed after operation S950 of FIG. 9 is performed.

Referring to FIG. 9, in operation S910, the server 100 obtains the use environment information from the new home appliance. The ‘new home appliance’ refers to a home appliance identified as a new device in operation S420 of FIG. 4. According to an embodiment of the disclosure, the processor 120 (see FIG. 2) of the server 100 may receive the use environment information from the new home appliance or the external server, through the communication interface 110 of FIG. 2. The use environment information represents information about an environment or situation where the new home appliance is currently being used. Referring to FIGS. 9 and 10, use environment information 1020 may include information about a day of the week, a usage time, fine dust, humidity, and an external temperature in which the new home appliance is used.

In operation S920, the server 100 extracts a feature value from the use environment information. Referring to FIGS. 9 and 10, the processor 120 may extract a plurality of feature values from the information included in the use environment information 1020, and may generate a second feature vector 1022 by using the extracted plurality of feature values. The processor 120 may extract the plurality of feature values from the information about a use environment of the new home appliance, for example, a day of the week, a usage time, fine dust, humidity, and an external temperature, which is included in the use environment information 1020, by using, for example, the encoding algorithm or the tokenization algorithm.

In operation S930, the server 100 generates a feature vector by using the feature value extracted from the use environment information and a feature value extracted from second cycle history data. Referring to FIGS. 9 and 10, second cycle history data 1010 is obtained by the processor 120 converting first cycle history data, which is history information about a cycle executed by the existing home appliance, into a cycle history executable by the new home appliance, by using the data conversion module 134 of FIG. 2. According to an embodiment of the disclosure, the processor 120 may obtain the second cycle history data 1010 by converting first cycle history data pre-stored in the cycle history data storage 135 of FIG. 2 by using the data conversion module 134. However, embodiments of the disclosure are not limited thereto, and, when the first cycle history data is received from the existing home appliance, the processor 120 may convert the first cycle history data in a raw data state into the second cycle history data 1010 in a raw data state by using the data conversion module 134, and may store the second cycle history data 1010 in the cycle history data storage 135 of FIG. 2.

The processor 120 may extract a plurality of feature values from the second cycle history data 1010, by using, for example, the encoding algorithm or the tokenization algorithm, and may generate a feature vector 1012 by using the extracted plurality of feature values. According to an embodiment of the disclosure, the processor 120 may extract the plurality of feature values from information about a course name of a frequently used course, setting values (for example, a washing temperature, a rinsing number, and a spinning intensity) regarding a plurality of operations included in the course, a use time (for example, an average use time), and a frequent use day of the week (for example, weekends or a weekday), which is included in the second cycle history data 1010.

The processor 120 may generate an n-dimensional feature vector by using the first feature vector 1012 obtained from the second cycle history data 1010 and the second feature vector 1022 obtained from the use environment information 1020.

In operation S940, the server 100 may obtain a label representing a recommended course, by applying a feature vector as input data to the AI model and performing inference through the AI model. The AI model 132 of FIG. 10 may be a machine learning model trained through supervised learning in which at least one of cycle history data or usage environment information of a home appliance is applied as input data and a label for a course used by a user is applied as an output value (e.g., ground-truth). The AI model 132 may be at least one model among, for example, a decision tree, a random forest, a Naïve Bayes classification network, a support vector machine (SVM), and an artificial neural network, but embodiments of the disclosure are not limited thereto.

According to an embodiment of the disclosure, the AI model 132 may be an ensemble model having a structure in which a plurality of decision trees are combined. When the AI model 132 is implemented as an ensemble model, the AI model 132 may be, for example, a boosting model.

Referring to the embodiment of FIG. 10, the processor 120 may obtain a label 1030 regarding a course predicted to be used by a user through a new home appliance, by applying the first feature vector 1012 obtained from the second cycle history data 1010 and the second feature vector 1022 obtained from the use environment information 1020 as the input data to the AI model 132 and performing inference using the AI model 132.

In operation S950, the server 100 obtains the information about the recommended course, based on the label. Referring to the embodiment of FIG. 10, when a day of the week when the new home appliance is used is the weekend and a course frequently used on the weekend is a denim course, the AI model 132 may output the label 1030 representing a ‘denim course’, which is the course predicted to be used by the user on the weekend from the second cycle history data 1010 and the use environment information 1020. The processor 120 may obtain the ‘denim course’ as the information about the recommended course, based on the label 1030. According to an embodiment of the disclosure, the processor 120 may control the communication interface 110 of FIG. 2 to transmit the information about the recommended course to the new home appliance.

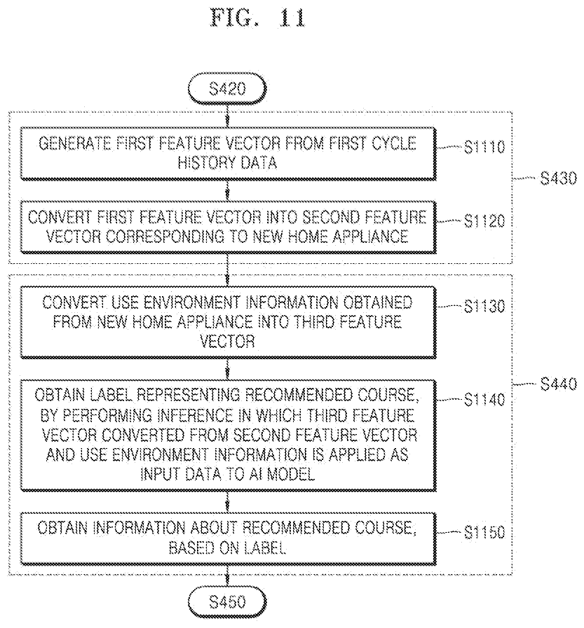

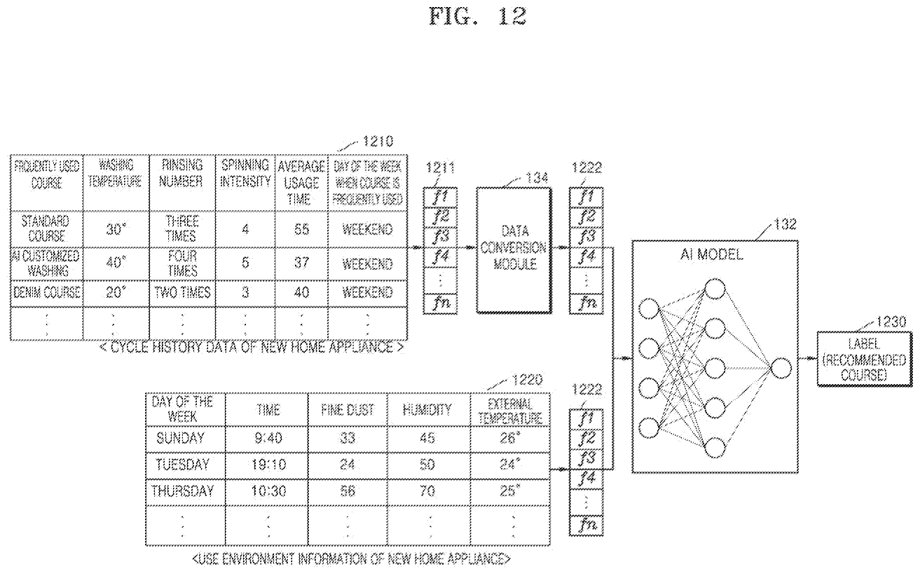

FIG. 11 is a flowchart of an operation, performed by the server 100 according to an embodiment of the disclosure, of obtaining information about a recommended course, based on the cycle history data obtained to correspond to the new home appliance and the use environment information, and FIG. 12 is a diagram for explaining the operation, performed by the server 100 according to an embodiment of the disclosure, of obtaining information about a recommended course, based on the cycle history data obtained to correspond to the new home appliance and the use environment information.

An embodiment of obtaining information about a recommended course, based on the cycle history data obtained to correspond to the new home appliance and the use environment information will now be described with reference to FIGS. 11 and 12.

Operations S1110 and S1120 of FIG. 9 are detailed operations of operation S430 of FIG. 4. Operations S1130 through S1150 of FIG. 9 are detailed operations of operation S440 of FIG. 4. Operation S1110 of FIG. 11 may be performed after operation S420 of FIG. 4 is performed. Operations S450 of FIG. 4 may be performed after operation S1150 of FIG. 11 is performed.

Referring to FIG. 11, in operation S1110, the server 100 generates a first feature vector from first cycle history data. The first cycle history data may be information about a cycle history performed by the existing home appliance. Referring to FIGS. 11 and 12, the processor 120 (see FIG. 2) of the server 100 may extract a plurality of feature values from first cycle history data 1210 of the existing home appliance and may obtain a first feature vector 1211 by using the extracted plurality of feature values. The processor 120 may extract the plurality of feature values from information about a course name of a frequently used course, setting values (for example, a washing temperature, a rinsing number, and a spinning intensity) regarding a plurality of operations included in the course, a use time (for example, an average use time), and a frequent use day of the week (for example, weekends or a weekday), which is included in the first cycle history data 1210, by using, for example, the encoding algorithm or the tokenization algorithm.

In operation S1120, the server 1000 converts the first feature vector into a second feature vector corresponding to the new home appliance. Referring to FIGS. 11 and 12, the processor 120 may input the first feature vector 1211 to the data conversion module 134, and may convert the first feature vector 1211 into a second feature vector 1212 corresponding to the new home appliance by using the data conversion module 134. The ‘new home appliance’ refers to a home appliance identified as a new device in operation S420 of FIG. 4. According to an embodiment of the disclosure, the data conversion module 134 may output the second feature vector 1212 by converting the plurality of feature values included in the first feature vector 1211 into feature values representing a course executable by the new home appliance and setting values of the course.

In operation S1130, the server 100 converts the use environment information obtained from the new home appliance into a third feature vector. According to an embodiment of the disclosure, the processor 120 may receive the use environment information from the new home appliance or the external server, through the communication interface 110 of FIG. 2. The use environment information represents information about an environment or situation where the new home appliance is currently being used. Referring to FIGS. 11 and 12, use environment information 1220 may include information about a day of the week, a usage time, fine dust, humidity, and an external temperature in which the new home appliance is used. According to an embodiment of the disclosure, the processor 120 may extract the plurality of feature values from the information about a use environment of the new home appliance, for example, a day of the week, a usage time, fine dust, humidity, and an external temperature, which is included in the use environment information 1220, by using the encoding algorithm or the tokenization algorithm. The processor 120 may generate a third feature vector 1222 by using the extracted plurality of feature values.

In operation S1140, the server 100 obtains a label representing a recommended course, by performing inference in which the third feature vector converted from the second feature vector and the use environment information is applied as input data to the AI model. The AI model 132 of FIG. 12 may be a machine learning model trained through supervised learning in which a feature vector obtained from cycle history data of a home appliance and a feature vector obtained from usage environment information of the home appliance are applied as input data and a label for a course used by a user is applied as an output value (e.g., ground-truth). The AI model 132 may be at least one model among, for example, a decision tree, a random forest, a Naïve Bayes classification network, a support vector machine (SVM), and an artificial neural network, but embodiments of the disclosure are not limited thereto.

According to an embodiment of the disclosure, the AI model 132 may be an ensemble model having a structure in which a plurality of decision trees are combined. When the AI model 132 is implemented as an ensemble model, the AI model 132 may be, for example, a boosting model.

Referring to the embodiment of FIG. 12, the processor 120 may obtain a label 1230 regarding a course predicted to be used by a user through the new home appliance, by applying the second feature vector 1212 obtained from the first feature vector 1211 through conversion and output by the data conversion module 134 and the third feature vector 1222 obtained from the use environment information 1220 as the input data to the AI model 132 and performing inference using the AI model 132.

In operation S1150, the server 100 obtains the information about the recommended course, based on the label. Referring to the embodiment of FIG. 12, when a day of the week when the new home appliance is used is the weekday and a course frequently used on the weekday is an AI customized course, the AI model 132 may output a label 1230 representing an ‘AI course’, which is the course predicted to be used by the user on the weekday from the second cycle history data 1212 and the third feature vector 1222. The processor 120 may obtain the ‘AI course’ as the information about the recommended course, based on the label 1230. According to an embodiment of the disclosure, the processor 120 may control the communication interface 110 of FIG. 2 to transmit the information about the recommended course to the new home appliance.

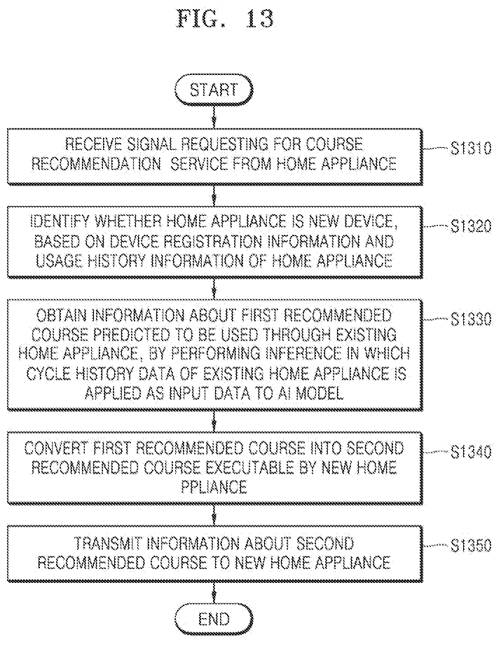

FIG. 13 is a flowchart of an operation method of the server 100 according to an embodiment of the disclosure.

In operation S1310, the server 100 receives a signal requesting for a course recommendation service from a home appliance. The ‘course recommendation service’ refers to a service in which the server 100 provides information about a course predicted to be used by a user through inference using the AI model 132 of FIG. 2, based on at least one of cycle history data or use environment information. According to an embodiment of the disclosure, the server 100 may receive the use environment information from the home appliance or an external server. The use environment information is information about an environment or situation in which the home appliance is currently being used, and may include, for example, information about at least one of a usage time, a usage date, day of the week, an external temperature, humidity, or fine dust.

In operation S1320, the server 100 identifies whether the home appliance is a new device, based on device registration information and usage history information of the home appliance. According to an embodiment of the disclosure, when a device registration period of the home appliance is within a preset threshold period and a use number of the home appliance is less than a preset threshold number, the server 100 may recognize the home appliance as a new device. The device registration period refers to a period between a date when the course recommendation service request signal is received from the home appliance and a date when the home appliance is registered in an IoT server. The server 100 may obtain the device registration information of the home appliance from the IoT server, and may identify the registration period of the home appliance from the device registration information. For example, when the registration period of the home appliance is within 21 days and the cycle use number of the home appliance is less than three times, the server 100 may determine that the home appliance is a new device.

In operation S1330, when the home appliance is determined as a new device, the server 100 obtains information about a first recommended course predicted to be used through an existing home appliance, by performing inference in which cycle history data of the existing home appliance is applied as input data to an AI model. The server 100 may load the first cycle history data of the existing home appliance pre-stored in the cycle history data storage 135 of FIG. 2, extract a plurality of feature values from the first cycle history data to obtain a feature vector, and perform inference through the AI model 132 by applying the feature vector as input data to the AI model 132 of FIG. 2. The server 100 may obtain, as a result of the inference, a label representing the first recommended course predicted to be used by the existing home appliance.

According to an embodiment of the disclosure, the server 100 may obtain the information about the first recommended course by performing inference in which not only the first cycle history data of the existing home appliance but also the use environment information received from the new home appliance or the external server are applied as input data to the AI model 132.

In operation S1340, the server 100 converts the first recommended course into a second recommended course executable by the home appliance. The server 100 may convert the first recommended course into the second recommended course executable by the new home appliance by using the data conversion module 134 of FIG. 2. The ‘new home appliance’ refers to the home appliance determined as a new device in operation S1320, and is distinguished from the existing home appliance in operation S1330.

According to an embodiment of the disclosure, the server 100 may convert the first recommended course into the second recommended course, based on a preset course mapping relationship between courses executable by the existing home appliance and courses executable by the new home appliance. For example, when an ‘AI customized course’ from among the courses executable by the existing home appliance is matched with an ‘AI course’ executed by the new home appliance in the course mapping table and the first recommended course is the ‘AI customized course’, the server 100 may convert the first recommended course into the second recommended course, which is the ‘AI course’, through the data conversion module 134.

According to an embodiment of the disclosure, the server 100 may convert the first recommended course into the second recommended course corresponding to the new home appliance, through inference in which the first recommended course is applied as input data to an AI conversion model. The AI conversion model may be a model trained through supervised learning in which a course executable by the existing home appliance and a feature value extracted from cycle information of the course are applied as input data and a label representing a course executable by the new home appliance is applied as an output value (for example, ground-truth). For example, when the first recommended course is the ‘AI customized course’, a label representing the ‘AI course’ executed by the new home appliance may be obtained as a result of the inference through the AI conversion model. The server 100 may convert the first recommended course into the ‘AI course’, based on the label obtained from the AI conversion model.

According to an embodiment of the disclosure, the server 100 may obtain a mapping relationship between first cycle information according to the course executable by the existing home appliance and second cycle information according to the course executable by the new home appliance, based on a similarity between the first cycle information and the second cycle information, and may convert the first recommended course into the second recommended course, based on the mapping relationship. For example, when the first recommended course is the ‘AI customized course’, a course having the second cycle information most similar to the first cycle information of the AI customized course from among the courses executable by the new home appliance may be the ‘AI course’. The server 100 may convert the first recommended course into the second recommended course, which is the ‘AI course’, based on the similarity between the first cycle information and the second cycle information.

In operation S1350, the server 100 transmits information about the second recommended course to the new home appliance. According to an embodiment of the disclosure, the server 100 may transmit not only the information about the second recommended course but also recommendation reason information about the second recommended course to the new home appliance.

According to the embodiment of FIG. 13, in contrast with the embodiment of FIGS. 1 through 12, the server 100 may obtain the information about the first recommended course from the first cycle history data of the existing home appliance, and may convert the first recommended course into the second recommended course by using the data conversion module 134.

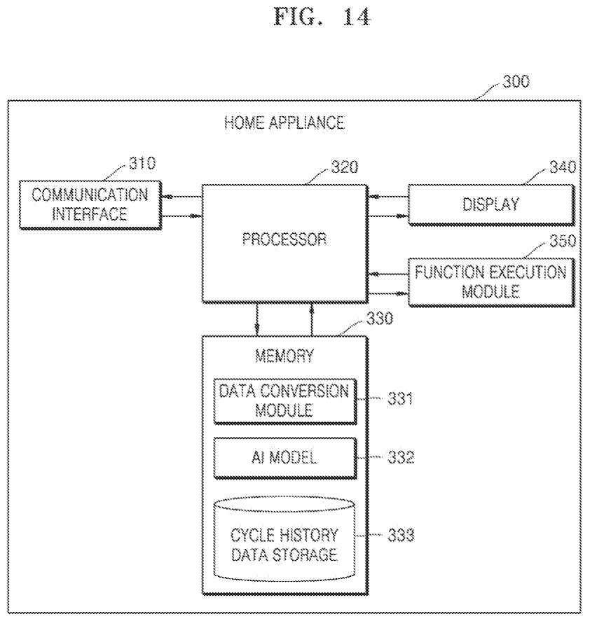

FIG. 14 is a block diagram of components of a home appliance 300 according to an embodiment of the disclosure.

The home appliance 300 may be a cycle-based home appliance configured to perform a cycle that executes a plurality of operations in a predetermined order. The home appliance 300 may be at least one of, for example, a washing machine, a clothes dryer, a clothes care system (e.g., an air dresser), or a shoes care system. However, embodiments of the disclosure are not limited thereto, and the home appliance 300 may be at least one of a TV, an air conditioner, an air purifier, a cleaning robot, a vacuum cleaner, an oven, a microwave oven, an induction cooktop, an audio device, or a smart home hub device.

The home appliance 300 may be a new device of which a device registration period is less than a preset threshold period and a cycle use number is less than a threshold number. According to an embodiment of the disclosure, the home appliance 300 may be a device of which the device registration duration is less than 21 days and the cycle use number is less than three times. The server 100 may determine whether the home appliance 300 is a new device, based on the device registration period and the cycle usage history information of the home appliance 300.

Referring to FIG. 14, the home appliance 300 may include a communication interface 310, a processor 320, a memory 330, a display 340, and a function execution module 350. The communication interface 310, the processor 320, the memory 330, the display 340, and the function execution module 350 may be electrically and/or physically connected to one another.

The components shown in FIG. 14 is only according to an embodiment of the disclosure, and the components included in the home appliance 300 are not limited to those shown in FIG. 14. The home appliance 300 may not include some of the components illustrated in FIG. 14, and may further include components not illustrated in FIG. 14. For example, when the home appliance 300 is a washing machine, the home appliance 300 may further include a door opening/closing sensor or a laundry weight detecting sensor. As another example, the home appliance 300 may further include a speaker for outputting a voice or sound signal.

The communication interface 310 is configured to perform data communication with the server 100 or a mobile device through a wired or wireless communication network.

The communication interface 310 may perform data exchange with the server 100 or the mobile device by using at least one of data communication methods including, for example, a wired LAN, a wireless LAN, Wi-Fi, Bluetooth, Zigbee, Wi-Fi Direct (WFD), infrared communication (IrDA), Bluetooth Low Energy (BLE), Near Field Communication (NFC), Wireless Broadband Internet (Wibro), World Interoperability for Microwave Access (WiMAX), a shared wireless access protocol (SWAP), Wireless Gigabit Alliance (WiGig), or RF communication.

The processor 320 may execute one or more instructions or program codes stored in the memory 330, and may perform functions and/or operations corresponding to the instructions or program codes. The processor 320 may include hardware components that perform arithmetic, logic, input/output operations and signal processing. The processor 320 may include, but is not limited to, at least one of a central processing unit, a microprocessor, a graphics processing unit, an application processor (AP), application specific integrated circuits (ASICs), digital signal processors (DSPs), digital signal processing devices (DSPDs), programmable logic devices (PLDs), or field programmable gate arrays (fPGAs).

The processor 320 is illustrated as a single element in FIG. 14, but embodiments of the disclosure are not limited thereto. According to an embodiment of the disclosure, the processor 320 may be provided as one or in plurality.

According to an embodiment of the disclosure, the processor 320 may be a dedicated hardware chip that performs AI learning.

Instructions and program code readable by the processor 320 may be stored in the memory 330. The memory 330 may be at least one type of storage medium from among, for example, a flash memory type storage medium, a hard disk type storage medium, a multimedia card micro type storage medium, a card type memory (for example, SD or XD memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

The memory 330 may include a data conversion module 331, an AI model 332, and a cycle history data storage 333. The data conversion module 331, the AI model 332, and the cycle history data storage 333 included in the memory 330 may refer to a unit for processing a function or operation performed by the processor 320, and may be implemented as software such as instructions or program code.

According to an embodiment below, the processor 320 may be implemented by executing the instructions or program codes of a program stored in the memory 330.

The data conversion module 331 is a software module configured to convert first cycle history data about an existing home appliance into second cycle history data corresponding to the home appliance 300. According to an embodiment of the disclosure, the data conversion module 331 may be stored in the memory 330 of the home appliance 300 from the time of initial product shipment, but embodiments of the disclosure are not limited thereto. According to another embodiment of the disclosure, the data conversion module 331 may be downloaded from the server 100 through the communication interface 310 and stored in a storage space of the memory 330. In this case, the data conversion module 331 may be configured with the same instructions or program codes as the data conversion module 134 (see FIG. 2) included in the server 100.

The processor 320 may download the first cycle history data about the existing home appliance from the server 100 through the communication interface 310, and may store the downloaded first cycle history data in the cycle history data storage 333. The first cycle history data may include information about at least one of the course name of a course performed by the existing home appliance, the frequency of use for each course, the time of use for each course, the date of use for each course, a day of the week for each course, or setting values related to a plurality of operations included in each course. The processor 320 may convert the course name of a course used by the existing home appliance and setting values relating to a plurality of operations included in the course, which are included in the first cycle history data, into a course name and setting values relating to a course executable by the home appliance 300, respectively, by executing instructions or program codes relating to the data conversion module 134.

According to an embodiment of the disclosure, the processor 320 may convert the first cycle history data into the second cycle history data, based on a course mapping relationship between the courses of the existing home appliance and the courses of the new home appliance.

According to an embodiment of the disclosure, the processor 320 may convert the first cycle history data into the second cycle history data corresponding to the new home appliance, through inference in which the first cycle history data is applied as input data to an AI conversion model. The AI conversion model may be a model trained through supervised learning in which a course executable by the existing home appliance and a feature value extracted from cycle information of the course are applied as input data and a label representing a course executable by the new home appliance is applied as an output value (for example, ground-truth). The AI conversion model may be included in the data conversion module 331, but embodiments of the disclosure are not limited thereto. According to an embodiment of the disclosure, the AI conversion model may be stored in a storage space in the memory 330 accessible by the processor 320.

According to an embodiment of the disclosure, the processor 320 may extract at least one feature value from the first cycle history data of the existing home appliance, and may obtain a label through inference using the AI conversion model by applying the extracted at least one feature value as the input data to the AI conversion model. The processor 320 may obtain the second cycle history data corresponding to the new home appliance from the first cycle history data, based on the obtained label.

A detailed method, performed by the processor 320, of converting the first cycle history data into the second cycle history data by using the data conversion module 331 is the same as the method by the data conversion module 134 (see FIG. 2) of the server 100, and thus a redundant description thereof will be omitted.

The AI model 332 is trained to output a label representing a course predicted to be used by a user through the home appliance 300, by performing inference in which at least one of the second cycle history data obtained to correspond to the home appliance 300 or the use environment information is applied as input data. According to an embodiment of the disclosure, the AI model 332 may be a machine learning model trained through supervised learning in which at least one of the first cycle history data or the usage environment information of the existing home appliance is applied as input data and a label for a course used by the user is applied as an output value (e.g., ground-truth). The AI model 332 may be at least one model among, for example, a decision tree, a random forest, a Naïve Bayes classification network, a support vector machine (SVM), and an artificial neural network, but embodiments of the disclosure are not limited thereto. According to an embodiment of the disclosure, the AI model 332 may be an ensemble model having a structure in which decision trees are combined.

According to an embodiment of the disclosure, the AI model 332 may be stored in the memory 330 of the home appliance 300 from the time of initial product shipment, but embodiments of the disclosure are not limited thereto. According to another embodiment of the disclosure, the AI model 332 may be downloaded from the server 100 through the communication interface 310 and stored in a storage space of the memory 330. In this case, the AI model 332 may be configured with the same instructions or program codes as the AI model 132 (see FIG. 2) included in the server 100, and may include the same parameters as the AI model 132.

According to an embodiment of the disclosure, the processor 320 may obtain the information about the course predicted to be used by the user through the home appliance 300, by applying the second cycle history data as the input data to the AI model 332 and performing inference using the AI model 332.

The processor 320 may display a UI indicating the obtained information about the course through the display 340. According to an embodiment of the disclosure, the processor 320 may obtain not only a result of the inference through the AI model 332 and the information about the recommended course but also information about a recommendation reason. The processor 320 may display a UI indicating the information about the recommendation reason through the display 340. An embodiment in which the home appliance 300 displays a UI representing the information about the recommended course and the recommendation reason will be described later with reference to FIGS. 16A and 16B.

However, embodiments of the disclosure are not limited thereto, and the processor 320 may output a voice message indicating at least one of the recommended course or the recommendation reason through a speaker.

The cycle history data storage 333 is a database that stores the first cycle history data downloaded from the server 100. According to an embodiment of the disclosure, the cycle history data storage 333 may store the second cycle history data obtained by the data conversion module 331.

The cycle history data storage 333 may be a non-volatile memory. The non-volatile memory refers to a storage medium that may store and maintain information even when power is not supplied and may use the stored information again when power is supplied. The non-volatile memory may include, for example, at least one of a flash memory, a hard disk, a solid state drive (SSD), a multimedia card micro type, and a card type memory (e.g., SD or XD memory), a ROM, a magnetic disk, or an optical disk.

FIG. 14 illustrates that the cycle history data storage 333 is included in the memory 330, but embodiments of the disclosure are not limited thereto. According to an embodiment of the disclosure, the cycle history data storage 333 may be included in the home appliance 300 but may be a separate component independent from the memory 330. However, embodiments of the disclosure are not limited thereto, and the cycle history data storage 333 is not included in the home appliance 300 but may be implemented as an external memory or as a web-based storage medium.

The display 340 may display a UI representing the information about the recommended course or the recommendation reason, under a control by the processor 320. The display 340 may be a physical device including at least one of a liquid crystal display (LCD), a thin film transistor-liquid crystal display (TFT-LCD), an organic light-emitting diode (OLED), a flexible display, a three-dimensional (3D) display, or an electrophoretic display, but embodiments of the disclosure are not limited thereto. According to an embodiment of the disclosure, the display 340 may be configured as a touch screen including a touch interface.

The function execution module 350 is configured to perform an original function and/or operation of the home appliance 300. For example, when the home appliance 300 is a washing machine, the function execution module 350 may include a washing tub, a motor, a door, a door opening/closing sensor, a water supply unit, a drain unit, and the like. As another example, when the home appliance 300 is a clothes care system, the function execution module 350 may include a blowing fan, a steam generator, a compressor, a condensate discharge pump, and the like.

The home appliance 300 according to the embodiment shown in FIG. 14 includes the data conversion module 331 and the AI model 332, and thus, in contrast with the embodiment of FIGS. 1 through 13, the home appliance 300 may convert the first cycle history data of the existing home appliance into the second cycle history data by an on-device method without using the server 100, and may provide information about a recommended course, based on the second cycle history data. According to an embodiment of the disclosure, because the home appliance 300 obtains the information about the recommended course in the on-device manner, a processing speed may be improved compared with a case where the recommended course is provided through the server 100, and a network usage cost generated during communication with the server 100 may be saved.

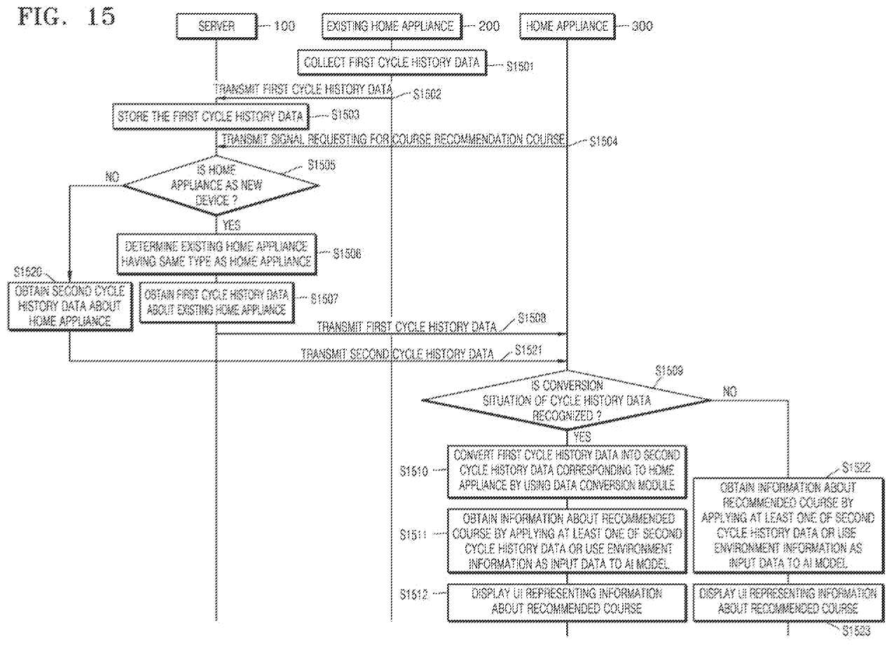

FIG. 15 is a flowchart of respective operations of the server 100, the existing home appliance 200, and the home appliance 300 and a data flow therebetween, according to an embodiment of the disclosure.

Referring to FIG. 15, the server 100, the existing home appliance 200, and the home appliance 300 may be connected to each other through a wired or wireless communication network, and may transmit or receive data. For example, the existing home appliance 200 and the home appliance 300 may be connected to the server 100 by using at least one data communication network from among, for example, a wired LAN, a wireless LAN, Wi-Fi, Bluetooth, Zigbee, Wi-Fi Direct (WFD), Bluetooth Low Energy (BLE), Wireless Broadband Internet (Wibro), World Interoperability for Microwave Access (WiMAX), a shared wireless access protocol (SWAP), Wireless Gigabit Allicance (WiGig), and RF communication, and may transmit or receive data to or from the server 100.

In operation S1501, the existing home appliance 200 collects first cycle history data. The existing home appliance 200 may store the first cycle history data representing an execution history of a cycle every time the cycle is executed by a user. The first cycle history data may include, for example, information about at least one of a course name used by the existing home appliance 200, the frequency of use for each course, the time of use for each course, the date of use for each course, a day of the week for each course, or setting values related to a plurality of operations included in each course.

In operation S1502, the existing home appliance 200 transmits the first cycle history data to the server 100. The existing home appliance 200 may transmit the first cycle history data to the server 100 at predetermined intervals, or may transmit the first cycle history data to the server 100 every time a cycle is performed.

In operation S1503, the server 100 stores the first cycle history data. The server 100 may store the first cycle history data received from the existing home appliance 200, in the cycle history data storage 135 of FIG. 2.

In operation S1504, the home appliance 300 transmits a signal requesting for a course recommendation course to the server 100. The ‘course recommendation service’ refers to a service in which the server 100 provides information about a course predicted to be used by a user through inference using the AI model 132 of FIG. 2, based on at least one of cycle history data or use environment information.

In operation S1505, the server 100 determines whether the home appliance 300 is identified as a new device. According to an embodiment of the disclosure, when a device registration period of the home appliance 300 is within a preset threshold period and a use number of the home appliance 300 is less than a preset threshold number, the server 100 may determine the home appliance as a new device. The device registration period refers to a period between a date when the course recommendation service request signal is received from the home appliance 300 and a date when the home appliance 300 is registered in the IoT server. The server 100 may obtain the device registration information of the home appliance 300 from the IoT server, and may identify a registration period of the home appliance 300 from the device registration information. For example, when the registration period of the home appliance 300 is within 21 days and the cycle use number of the home appliance 300 is less than three times, the processor 100 may determine that the home appliance 300 is a new device.

When the home appliance 300 is determined as a new device (operation S1506), the server 100 determines the existing home appliance 200 having the same type as the home appliance 300. According to an embodiment of the disclosure, the server 100 may identify the existing home appliance 200 corresponding to the home appliance 300, based on registration information and user identification information (for example, a user ID) of the home appliance 300. According to an embodiment of the disclosure, the server 100 may identify the existing home appliance 200 having the same type as the home appliance 300 and installed at the same location as or a location adjacent to the location of the home appliance 300, from among one or more home appliances registered together with the home appliance 300 in the user identification information at which the home appliance 300 is registered in the IoT server.

In operation S1507, the server 100 obtains the first cycle history data about the existing home appliance 200. According to an embodiment of the disclosure, the server 100 may load the first cycle history data of the existing home appliance 200 from the cycle history data storage 135.

In operation S1508, the server 100 transmits the first cycle history data to the home appliance 300. According to an embodiment of the disclosure, the server 100 may transmit the data conversion module 134 of FIG. 2 together with the first cycle history data and to the home appliance 300. The server 100 may transmit the instructions or program code constituting the data conversion module 134 to the home appliance 300, and the home appliance 300 may download the data conversion module 134 from the server 100.

According to an embodiment of the disclosure, the server 100 may transmit the instructions or program code constituting the AI model 132 of FIG. 2 to the home appliance 300.

In operation S1509, the home appliance 300 recognizes a conversion situation of cycle history data. According to an embodiment of the disclosure, the home appliance 300 may identify whether the cycle history data received from the server 100 corresponds to the home appliance 300 or corresponds to the existing home appliance 200, and may recognize the conversion situation of the cycle history data according to a result of the identification.

The home appliance 300 may determine whether the first cycle history data received from the server 100 is cycle history data corresponding to the home appliance 300. According to an embodiment of the disclosure, the home appliance 300 may determine whether a course included in the first cycle history data and setting values of a plurality of operations constituting the course are a course executable by the home appliance 300 and setting values of the course. The home appliance 300 may recognize the conversion situation of the cycle history data, based on a result of the determination. According to an embodiment of the disclosure, the home appliance 300 may identify that the first cycle history data is data representing the cycle use history of the existing home appliance 200, and may recognize that conversion of the cycle history data is necessary.

When the conversion situation of the cycle history data is recognized (operation S1510), the home appliance 300 converts the first cycle history data into second cycle history data corresponding to the home appliance 300 by using a data conversion module. According to an embodiment of the disclosure, the processor 320 (see FIG. 14) of the home appliance 300 may convert the first cycle history data into the second cycle history data by executing the instructions or program code of the data conversion module 331 of FIG. 14. A method, performed by the home appliance 300, of converting the cycle history data by using the data conversion module 331 is the same as that described in FIG. 14, and thus a redundant description thereof will be omitted.

In operation S1511, the home appliance 300 obtains information about a recommended course by applying at least one of the second cycle history data or the use environment information as input data to the AI model. According to an embodiment of the disclosure, the processor 320 of the home appliance 300 may obtain a label representing a course predicted to be used by a user through the home appliance 300, by applying at least one of the second cycle history data or the use environment information as input data to the AI model 332 of FIG. 14 and performing inference through the AI model 332. The processor 320 may obtain the information about the recommended course, based on the label. A detailed method, performed by the processor 320, of obtaining the information about the recommended course by using the AI model 332 is the same as that described in FIG. 14, and thus a redundant description thereof will be omitted.

In operation S1512, the home appliance 300 displays a UI representing the information about the recommended course. The home appliance 300 may display the UI indicating the information about the recommendation reason through the display 340 of FIG. 14. The home appliance 300 may obtain information about a reason why the label representing the recommended course is inferred, during inference through the AI model 332. According to an embodiment of the disclosure, the home appliance 300 may identify a feature value affecting a change in a weight or bias value within the AI model 332, and may obtain information about the course recommendation reason, based on the identified feature value. In this case, the home appliance 300 may display, through the display 340, a UI representing not only the information about the recommended course but also the information about the course recommendation reason.

When the home appliance 300 is not determined as a new device (operation S1520), the server 100 obtains the second cycle history data about the home appliance 300. According to an embodiment of the disclosure, the server 100 may identify the second cycle history data representing the cycle use history of the home appliance 300 from among one or more pieces of cycle history data pre-stored in the cycle history data storage 135 of FIG. 2, and may obtain the identified second cycle history data from the cycle history data storage 135.

In operation S1521, the server 100 transmits the second cycle history data to the home appliance 300.

In operation S1509, the home appliance 300 recognizes a conversion situation of cycle history data, based on the second cycle history data. Because the second cycle history data represents the cycle use history of the home appliance 300, there is no need to convert the cycle history data. Accordingly, the home appliance 300 may recognize that conversion of the cycle history data is unnecessary.

In operation S1522, the home appliance 300 obtains information about a recommended course by applying at least one of the second cycle history data or the use environment information as input data to the AI model.

In operation S1523, the home appliance 300 displays a UI representing the information about the recommended course.

Operations S1522 and S1523 are the same as operations S1511 and S1512, and thus redundant descriptions thereof will be omitted.

FIG. 16A is a view illustrating an operation, performed by a home appliance according to an embodiment of the disclosure, of displaying a UI representing a recommended course and setting values of the recommended course. FIG. 16A illustrates a case where the home appliance 300 is a washing machine 300a.

The washing machine 300a may be a device determined as a new device by the server 100. According to an embodiment of the disclosure, the washing machine 300a may be a new device of which a device registration period (e.g., 21 days) is less than a preset threshold period and a cycle use number (e.g., three times) is less than a threshold number.

Referring to FIG. 16A, the washing machine 300a may display, on the display 340, a UI representing a recommended course, setting values of the recommended course, and a recommendation reason. According to an embodiment of the disclosure, the washing machine 300a may display, through the display 340, a first UI 1610 indicating a recommended course, a second UI 1620 indicating setting values of the recommended course, and a third UI 1630 indicating a reason why the recommended course is recommended.

The first UI 1610 is a UI indicating information about the recommended course through at least one of characters, numbers, or images. According to the embodiment of FIG. 16A, the recommended course is ‘strong washing’, and the washing machine 300a may display, through the display 340, the first UI 1610 configured with a text ‘strong washing’.

The second UI 1620 represents setting values of a plurality of operations constituting the recommended course, in the form of characters or numbers. According to the embodiment of FIG. 16A, the washing machine 300a may display, on the display 340, the second UI 1620 indicating a washing temperature (for example, 40°), a rinsing number (for example, three times), and a spinning intensity (for example, 3), which are setting values relating to operations constituting a strong washing course, for example, washing, rinsing, and spinning.

The third UI 1630 indicates a course recommendation reason providing the recommended course in characters or numbers. According to an embodiment of the disclosure, the washing machine 300a may obtain the information about the course recommendation reason from the server 100. According to an embodiment of the disclosure, the server 100 may identify a feature value that has affected a change in a weight or bias value within the AI model 132, and may transmit information about the identified feature value to the washing machine 300a, during prediction of the recommended course through the AI model 132 of FIG. 2. The washing machine 300a may obtain the information about the course recommendation reason, based on the information about the identified feature value received from the server 100, and may display the third UI 1630 indicating the information about the course recommendation reason. However, embodiments of the disclosure are not limited thereto, and the washing machine 300a may obtain the information about the course recommendation reason in the on-device manner by using an AI model included in a memory, and may display the third UI 1630 indicating the course recommendation reason.

According to the embodiment of FIG. 16A, the washing machine 300a may display the third UI 1630 composed of the text “used frequently on weekends” as a reason for recommending the strong washing course.

FIG. 16B is a view illustrating an operation, performed by a home appliance according to an embodiment of the disclosure, of displaying a UI representing a recommended course. FIG. 16B illustrates a case where the home appliance 300 is a clothes care system 300b.

The clothes care system 300b is a device that applies dry air or steam to clothes to perform a predetermined treatment (e.g., dust removal, wrinkle removal, or odor removal) on the clothes. The clothes care system 300b may be a cycle-based home appliance that performs a plurality of operations for performing a predetermined processing process related to clothes in a predetermined order. The clothes care system 300b may be, for example, an air dresser, but embodiments of the disclosure are not limited thereto.

The clothes care system 300b may be a device determined as a new device by the server 100. According to an embodiment of the disclosure, the clothes care system 300b may be a new device in which a device registration period (e.g., 21 days) is less than a preset threshold period and a cycle use number (e.g., three times) is less than a threshold number.

Referring to FIG. 16B, the clothes care system 300b may display, on the display 340, a UI representing a recommended course, setting values of the recommended course, and a recommendation reason. According to an embodiment of the disclosure, the clothes care system 300b may display, through the display 340, a first UI 1640 indicating a recommended course and a second UI 1650 indicating a course recommendation reason.

The first UI 1640 is a UI indicating information about the recommended course through at least one of characters, numbers, or images. According to the embodiment of FIG. 16B, the recommended course is a ‘fine dust course’, and the clothes care system 300b may display, through the display 340, the first UI 1640 configured with a text ‘fine dust course’.

The second UI 1650 indicates a course recommendation reason providing the recommended course in characters or numbers. According to the embodiment of FIG. 16B, the clothes care system 300b may display the second UI 1650 composed of the text “frequently used on days with severe fine dust” as a reason for recommending the fine dust course. A method, performed by the clothes care system 300b, of obtaining the information about the course recommendation reason is the same as that described in FIG. 16A, and thus a redundant description thereof will be omitted.

According to the embodiment of FIGS. 16A and 16B, even when the device registration period is less than the threshold period and the cycle use number is less than the threshold number, the washing machine 300a and the clothes care system 300b may display the first UIs 1610 and 1640 indicating the information about the recommended course and the third UI 1630 of FIG. 16A and the second UI 1650 of FIG. 16B each indicating the course recommendation reason. According to the embodiment of FIGS. 16A and 16B, even when a user newly purchases the washing machine 300a or the clothes care system 300b to replace an existing washing machine or an existing clothes care system or the new washing machine 300a or the new clothes care system 300b is added to the existing washing machine or the existing clothes care system, the user may be provided with not only the recommended course but also the information about the recommendation reason, and thus user convenience may be improved.

The program executed by the server 100 described above herein may be implemented as a hardware component, a software component, and/or a combination of hardware components and software components. The program may be executed by any system capable of executing computer readable instructions.

The software may include a computer program, a code, instructions, or a combination of one or more of the foregoing, and may constitute a processing device so that the processing device can operate as desired, or may independently or collectively instruction the processing device.

The software may be implemented as a computer program including instructions stored in computer-readable storage media. Examples of the computer-readable recording media include magnetic storage media (e.g., ROM, floppy disks, hard disks, etc.), and optical recording media (e.g., CD-ROMs, or digital versatile discs (DVDs)). The computer-readable recording media can be distributed over network coupled computer systems so that the computer-readable code is stored and executed in a distributive manner. These media can be read by the computer, stored in a memory, and executed by a processor.

Computer-readable storage media may be provided in the form of non-transitory storage media. Here, ‘non-transitory’ means that the storage medium does not include a signal and is tangible, but does not distinguish a case where data is stored semi-permanently or temporarily in the storage medium. For example, the non-transitory storage media may include a buffer in which data is temporarily stored.

Programs according to various embodiments disclosed herein may be provided by being included in computer program products. Computer program products are commodities and thus may be traded between sellers and buyers.

Computer program products may include a software program and a computer-readable storage medium having the software program stored thereon. For example, computer program products may include a product in the form of a software program (e.g., a downloadable application) that is electronically distributed through electronic device manufacturers or electronic markets (e.g., Samsung Galaxy Store). For electronic distribution, at least a portion of the software program may be stored on a storage medium or may be created temporarily. In this case, the storage medium may be the server 100 or a storage medium of a relay server for temporarily storing a software program.

The computer program product may include a storage medium of the server 100 or a storage medium of the home appliance 300, in a system composed of the server 100, the existing home appliance 200, and/or the home appliance 300. Alternatively, in a case where there is a third device (e.g., a mobile device) in communication with the server 100, the computer program product may include a storage medium of the third device. Alternatively, the computer program product may include the software program itself transmitted from the server 100 to the third device, or transmitted from the third device to the server 100.

In this case, at least one of the server 100 or the home appliance 300 may execute the computer program product to perform the methods according to the disclosed embodiments. Alternatively, at least two of the server 100, the home appliance 300, or the third device may execute the computer program product to distribute and perform the methods according to the disclosed embodiments.

For example, the server 100 may control another electronic device (e.g., a mobile device) in communication with the home appliance 300 to perform the methods according to the disclosed embodiments, by executing the computer program product stored in the memory 130 of FIG. 2.

As another example, a third device may execute a computer program product to control an electronic device in communication with the third device to perform the methods according to the disclosed embodiments.

When the third device executes the computer program product, the third device may download the computer program product from the server 100 and execute the downloaded computer program product. Alternatively, the third device may execute a computer program product provided in a preloaded state to perform methods according to the disclosed embodiments.

While the disclosure has been particularly shown and described with reference to examples thereof, it will be understood by those of ordinary skill in the art that various changes in form and details may be made therein without departing from the spirit and scope of the disclosure as defined by the following claims. For example, an appropriate result may be attained even when the above-described techniques are performed in a different order from the above-described method, and/or components, such as the above-described computer system or module, are coupled or combined in a different form from the above-described methods or substituted for or replaced by other components or equivalents thereof.

What is claimed is:

1. A method, performed by a server, of providing an artificial intelligence (AI) service, the method comprising:
receiving, from a home appliance, a signal requesting a course recommendation service;
determining whether the home appliance is a new device, based on device registration information and usage history information of the home appliance;
when the home appliance is determined as the new device, converting existing first cycle history data associated with an existing home appliance before use of the home appliance and that is a same type as the home appliance into second cycle history data corresponding to the home appliance;
obtaining information associated with a recommended course of the home appliance by applying the second cycle history data as input data to an AI model; and
transmitting, to the home appliance, the information associated with the recommended course of the home appliance.

2. The method of claim 1, wherein the converting of the first cycle history data into the second cycle history data is based on a preset course mapping relationship between courses of the existing home appliance and courses of the home appliance.

3. The method of claim 1, wherein the AI model is a first AI model and the converting of the first cycle history data into the second cycle history data comprises:
extracting at least one feature value from the first cycle history data;
performing inference through a second AI model by applying the extracted at least one feature value as input data to the second AI model; and
converting the first cycle history data into the second cycle history data, based on a label obtained through the inference.

4. The method of claim 3, wherein the second AI model is a model trained through supervised learning in which a course executable by the existing home appliance and a feature value extracted from cycle information of the course are applied as input data and a label representing a course executable by the home appliance is applied as output data.

5. The method of claim 4, wherein the cycle information of the course comprises information associated with at least one of a plurality of operations included in a cycle constituting the course, an order of performing the plurality of operations, or setting values of the plurality of operations.

6. The method of claim 1, wherein the converting of the first cycle history data into the second cycle history data comprises:
obtaining a mapping relationship between first cycle information according to a course executable by the existing home appliance and second cycle information according to a course executable by the home appliance, based on a similarity between the first cycle information and the second cycle information; and
converting the first recommended course into the second recommended course, based on the obtained mapping relationship.

7. The method of claim 1, wherein the obtaining of the information associated with the recommended course of the home appliance comprises:
obtaining, from the home appliance, use environment information comprising information associated with at least one of a usage time, a usage date, a day of the week, an external temperature, humidity, or fine dust;
extracting a feature value from the use environment information;
generating a feature vector by using the extracted feature value and a feature value extracted from the second cycle history data; and
obtaining a label representing the recommended course of the home appliance, by applying the feature vector as input data to the AI model and performing inference through the AI model.

8. A server for providing an artificial intelligence (AI) service to a home appliance, the server comprising:
a communication interface;
a memory to store cycle history data of at least one home appliance and at least one instruction; and
at least one processor configured to execute the at least one instruction stored in the memory to:
receive a signal requesting a course recommendation service from the home appliance through the communication interface,
determine whether the home appliance is a new device, based on device registration information and usage history information of the home appliance,
when the home appliance is determined as the new device, convert existing first cycle history data associated with an existing home appliance before use of the home appliance and that is a same type as the home appliance into second cycle history data corresponding to the home appliance, obtain information associated with a recommended course of the home appliance by applying the second cycle history data as input data to a first AI model, and
control the communication interface to transmit, to the home appliance, the information associated with the recommended course of the home appliance.

9. The server of claim 8, wherein the at least one processor is further configured to convert the first cycle history data into the second cycle history data, based on a preset course mapping relationship between courses of the existing home appliance and courses of the new home appliance.

10. The server of claim 8, wherein the at least one processor is further configured to:
extract at least one feature value from the first cycle history data;
perform inference through a second AI model by applying the extracted at least one feature value as input data to the second AI model; and
convert the first cycle history data into the second cycle history data, based on a label obtained through the inference.

11. The server of claim 10, wherein the second AI model is a model trained through supervised learning in which a course executable by the existing home appliance and a feature value extracted from cycle information of the course are applied as input data and a label representing a course executable by the home appliance is applied as output data.

12. The server of claim 11, wherein the cycle information of the course comprises information associated with at least one of a plurality of operations included in a cycle constituting the course, an order of performing the plurality of operations, or setting values of the plurality of operations.

13. The server of claim 8, wherein the at least one processor is further configured to:
obtain a mapping relationship between first cycle information according to the course executable by the existing home appliance and second cycle information according to the course executable by the home appliance, based on a similarity between the first cycle information and the second cycle information; and
convert the first recommended course into the second recommended course, based on the obtained mapping relationship.

14. The server of claim 8, wherein the at least one processor is further configured to:
obtain use environment information comprising information associated with at least one of a usage time, a usage date, a day of the week, an external temperature, humidity, or fine dust, from the home appliance through the communication interface; and
extract a feature vector from the use environment information, generate a feature vector by using the extracted feature value and a feature value extracted from the second cycle history data, and obtain a label representing the recommended course of the home appliance, by applying the feature vector as input data to the first AI model and performing inference through the first AI model.

15. A computer program product including a non-transitory computer-readable storage medium storing instructions executable by a server to cause the server to execute an operation comprising:
receiving, from a home appliance, a signal requesting a course recommendation service;
determining whether the home appliance is a new device, based on device registration information and usage history information of the home appliance;
converting, when the appliance is determined as the new device, existing first cycle history data associated with an existing home appliance before use of the home appliance and that is a same type as the home appliance into second cycle history data corresponding to the home appliance;
obtaining information associated with a recommended course by applying the second cycle history data as input data to a first artificial intelligence (AI) model; and
transmitting, to the home appliance, the information associated with the recommended course.
